(19) United States
(12) Patent Application Publication
(10) Pub. No.: US 2026/0357128 A1
(43) Pub. Date: Nov. 12, 2026

(54) COLOR CONVERSION COMPOSITION, COLOR CONVERSION SHEET, LIGHT SOURCE UNIT, DISPLAY DEVICE, AND ILLUMINATION APPARATUS

(71) Applicant: Toray Industries, Inc., Chuo-ku, Tokyo (JP)

(72) Inventor: Nanako IZUMI, Otsu-shi, Shiga (JP)

(73) Assignee: Toray Industries, Inc., Chuo-ku, Tokyo (JP)

(21) Appl. No.: 19/110,238

(22) PCT Filed: Aug. 24, 2023
(86) PCT No.: PCT/JP2023/030571

§ 371 Date: Mar. 10, 2025

(30) Foreign Application Priority Data
Sep. 16, 2022 (JP) 2022-147617

(51) Int. Cl. C09K 11/06; C09K 11/02; F21V 9/30; F21Y 115/10

(52) U.S. Cl. CPC C09K 11/06; C09K 11/02; F21V 9/30; C09K 2211/1007; C09K 2211/1018; F21Y 2115/10

(57) ABSTRACT

A color conversion composition is described that contains Component (A): a luminescent material, Component (B): a binder resin, and Component (C): a compound of the following general formula (1):

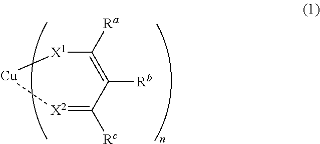

wherein X¹, X², R^{a} to R^{c}, and n are as defined.

### CROSS REFERENCE TO RELATED APPLICATIONS

This application is the U.S. National Phase of PCT/JP2023/030571, filed Aug. 24, 2023, which claims priority to Japanese Patent Application No. 2022-147617, filed Sep. 16, 2022, the disclosures of these applications being incorporated herein by reference in their entireties for all purposes.

### FIELD OF THE INVENTION

The present invention relates to a color conversion composition, a color conversion sheet, a light source unit, a display device, and an illumination apparatus.

### BACKGROUND OF THE INVENTION

The application of multi-color technology based on color conversion techniques to liquid crystal displays, organic EL displays, illumination apparatus, and the like is being actively studied. Color conversion represents to convert light emitted from a light emitter into light having a longer wavelength, and includes converting, for example, blue emission into green or red emission.

A composition having this color conversion function (hereinafter referred to as color conversion composition) is formed into a sheet and combined, for example, with a blue light source, and three primary colors of blue, green, and red can thereby be obtained from the blue light source, that is, white light can be obtained. A white light source obtained by combining such a blue light source with a sheet having a color conversion function (hereinafter referred to as color conversion sheet) is used as a light source unit such as a backlight unit, and such a light source unit is combined with a liquid crystal driving unit and a color filter, whereby a full-color display can be manufactured. Further, the white light source obtained by combining a blue light source with a color conversion sheet can be used as a white light source such as a LED illumination (illumination apparatus) as it is.

The problem to be solved in a liquid crystal display utilizing color conversion techniques includes improvement of color reproducibility and durability. To improve color reproducibility, narrowing a full width half maximum of each of the blue, green, red emission spectra of the light source unit to enhance the color purity of the blue, green, and red, is effective. As an example of a means to solve this task, color conversion materials containing a pyrromethene compound have been proposed (see, for example, Patent Literatures 1 and 2). In addition, a technology comprising adding a light stabilizer has been proposed as an example of a technology to improve the durability (see, for example, Patent Literatures 3 and 4).

### PATENT LITERATURE

Patent Literature 1: JP 2010-61824A
Patent Literature 2: JP 2014-136771A
Patent Literature 3: WO2017/014068
Patent Literature 4: WO2021/192795

### SUMMARY OF THE INVENTION

However, even when color conversion compositions were produced using organic luminescent materials described in Patent Literatures 1 to 3, they were still insufficient in terms of improvement of color reproducibility and durability (durability against light). In addition, it has been found that the technology described in Patent Literature 4 has a problem with humidity resistance and there is a problem of significant decrease in the fluorescence quantum yield under high temperature and high humidity.

Accordingly, an object of the present invention is to provide a color conversion composition, a color conversion sheet, a light source unit, a display device, and a illumination apparatus, which are excellent in durability against light and humidity resistance.

In order to solve the above problem and achieve the object, the present invention has a constitution described in any one of [1] to below.

That is,
[1] the color conversion composition according to the present invention contains the following components (A), (B), and (C):
Component (A): a luminescent material,
Component (B): a binder resin, and
Component (C): a compound of the following general formula (1):

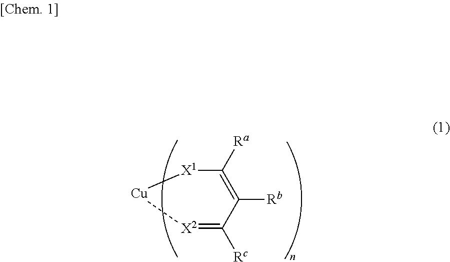

(wherein in the general formula (1), each of X¹ and X² independently is O or S; each of R^{a} to R^{c} is independently selected from the group consisting of a hydrogen atom, an alkyl group, a cycloalkyl group, a heterocyclic group, an alkenyl group, an alkynyl group, a hydroxyl group, an alkoxy group, a thiol group, an alkylthio group, an aryl ether group, an aryl thioether group, an aryl group, a heteroaryl group, halogen, a cyano group, an aldehyde group, an oxycarbonyl group, a carbamoyl group, an amino group, a nitro group, a silyl group, a siloxanyl group, a boryl group, a phosphine oxide group, —C(═O)R¹⁰¹, —S(═O)R¹⁰²R¹⁰³, —S(═O)R¹⁰⁴, —S(═O)₂R¹⁰⁵, and a fused ring or an aliphatic ring each formed between adjacent substituents; R¹⁰¹ to R¹⁰⁵ are substituents, and R¹⁰² and R¹⁰³ may be fused with each other to form a ring, provided that at least one of R^{a} to R^{c} is an electron withdrawing group; and n is an integer of 1 to 4).
[2] In the color conversion composition according to the present invention described above in [1], the electron withdrawing group is a group containing a fluorine atom.
[3] In the color conversion composition according to the present invention described above in [1] or [2], the electron withdrawing group is a group having 4 or more fluorine atoms.
[4] In the color conversion composition according to the present invention described above in any one of [1] to [3], the electron withdrawing group is a perfluoroalkyl group having 2 or more carbon atoms.
[5] In the color conversion composition according to the present invention described above in any one of [1] to [4], Rb in the general formula (1) is a hydrogen atom.
[6] In the color conversion composition according to the present invention described above in [1] or [5], X¹ and X² in the general formula (1) are both O.
[7] In the color conversion composition according to the present invention described above in any one of [1] to [6], the component (A) contains a compound of the following general formula (2):

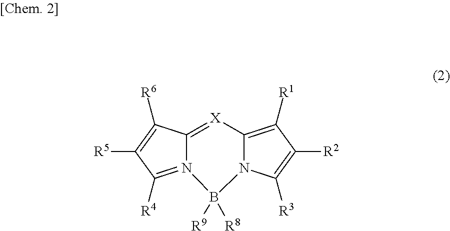

(wherein in the general formula (2), X is C—R⁷ or N; and
each of R¹ to R⁹, which may be the same as or different from one another, is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, a phosphine oxide group, and a fused ring or an aliphatic ring each formed between adjacent substituents).
[8] In the color conversion composition according to the present invention described above in [7], at least one of R¹ to R⁶ in the general formula (2) is an electron withdrawing group, X in the general formula (2) is C—R⁷, and the R⁷ is a group of the following general formula (3):

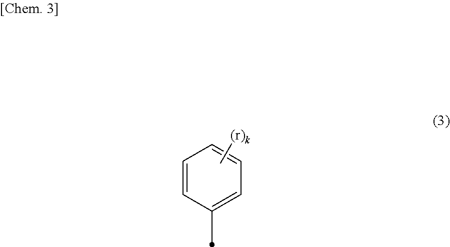

(wherein in the general formula (3),
r is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, and a phosphine oxide group;
k is an integer of 1 to 3; and
when k is 2 or more, r may be the same as or different from one another).
[9] In the color conversion composition according to the present invention described above in any one of [1] to [8], the component (A) contains at least one of the following luminescent materials (a) and (b):
luminescent material (a): a luminescent material that emits light having a peak wavelength observed in the region of 500 nm to less than 580 nm by use of excitation light having a wavelength of 400 nm to 500 nm, and
luminescent material (b): a luminescent material that emits light having a peak wavelength observed in the region of 580 nm to 750 nm upon being excited by at least one of excitation light having a wavelength of 400 nm to 500 nm and light emitted by the luminescent material (a).
[10] In the color conversion composition according to the present invention described above in any one of [1] to [9], the component (B) is a thermoplastic resin.
[11] A color conversion sheet according to the present invention includes the color conversion composition described above in any one of [1] to [10], or a cured product thereof.
[12] The light source unit according to the present invention includes:
a light source; and
the color conversion composition described above in any one of [1] to [10].
[13] In the light source unit according to the present invention described above in [12], the light source is a light-emitting diode having a maximum light emission in the range of 400 nm to 500 nm.
[14] A display device according to the present invention includes the light source unit described above in [12] or [13].
[15] A illumination apparatus according to the present invention includes the light source unit described above in [12] or [13].

### Advantageous Effects of Invention

The color conversion composition according to the present invention and the color conversion sheet using the same can improve durability and humidity resistance.

### BRIEF DESCRIPTION OF DRAWINGS

FIG. 1 is a schematic cross-sectional view illustrating the first example of the color conversion sheet according to the embodiment of the present invention.

FIG. 2 is a schematic cross-sectional view illustrating the second example of the color conversion sheet according to the embodiment of the present invention.

FIG. 3 is a schematic cross-sectional view illustrating the third example of the color conversion sheet according to the embodiment of the present invention.

FIG. 4 is a schematic cross-sectional view illustrating the fourth example of the color conversion sheet according to the embodiment of the present invention.

### DETAILED DESCRIPTION OF EMBODIMENTS OF THE INVENTION

Suitable embodiments of the color conversion composition, the color conversion sheet, light source unit, display device, and illumination apparatus according to the present invention will be specifically described below, but the present invention is not limited to the following embodiments and can be modified in various ways depending on the purpose and application.

### <Color Conversion Composition>

The color conversion composition according to the embodiment of the present invention (hereinafter sometimes abbreviated as the color conversion composition of the present invention) contains the component (A), component (B), and component (C) described below. In the present invention, the component (A) is a luminescent material, and the component (B) is a binder resin. The component (C) is a compound of the general formula (1) below.

### <Component (A): Luminescent Material>

The color conversion composition according to the embodiment of the present invention contains at least one luminescent material as the component (A). The luminescent material in the present invention refers to a material that when irradiated with a certain type of light emits light having a wavelength different from the wavelength of that light.

Examples of the luminescent material include inorganic fluorescent substance, fluorescent pigment, fluorescent dye, and quantum dot. The color conversion composition of the present invention may contain two or more luminescent materials as the component (A). In order to achieve high-efficiency color conversion, the component (A) is preferably a luminescent material exhibiting light emission characteristics with high quantum yield. For example, as the component (A), a quantum dot and an organic luminescent material are preferred. Among them, an organic luminescent material is more preferred.

Examples of the organic luminescent material are as follows. Examples of the suitable organic luminescent material include a compound having a fused aryl ring such as naphthalene, anthracene, phenanthrene, pyrene, chrysene, naphthacene, triphenylene, perylene, fluoranthene, fluorene, indene, and a derivative thereof. Examples of the suitable organic luminescent material further include a heteroaryl ring-containing compound and a derivative thereof, such as furan, pyrrole, thiophene, silole, 9-silafluorene, 9,9′-spirobisilafluorene, benzothiophene, benzofuran, indole, dibenzothiophene, dibenzofuran, imidazopyridine, phenanthroline, pyridine, pyrazine, naphthyridine, quinoxaline and pyrrolopyridine, and borane derivatives.

Examples of the suitable organic luminescent material further include stilbene derivatives such as 1,4-distyrylbenzene, 4,4′-bis(2-(4-diphenylaminophenyl) ethenyl) biphenyl, and 4,4′-bis(N-(stilben-4-yl)-N-phenylamino) stilbene; aromatic acetylene derivatives; tetraphenylbutadiene derivatives; aldazine derivatives; pyrromethene derivatives, and diketopyrrolo[3,4-c]pyrrole derivatives. Examples of the suitable organic luminescent material further include coumarin derivatives such as coumarin 6, coumarin 7, and coumarin 153; azole derivatives such as imidazole, thiazole, thiadiazole, carbazole, oxazole, oxadiazole, triazole, and metal complexes thereof; cyanine-based compounds such as indocyanine green; a xanthene-based compounds and thioxanthene-based compounds such as fluorescein, eosin, and rhodamine.

Examples of the suitable organic luminescent material further include polyphenylene-based compounds; naphthalimide derivatives; phthalocyanine derivatives and metal complexes thereof; porphyrin derivatives and metal complexes thereof; oxazine-based compounds such as Nile Red and Nile Blue; helicene-based compounds; and aromatic amine derivatives such as N,N′-diphenyl-N,N′-di(3-methylphenyl)-4,4′-diphenyl-1,1′-diamine. Examples of the suitable organic luminescent material further include organic metal complex compound of iridium (Ir), ruthenium (Ru), rhodium (Rh), palladium (Pd), platinum (Pt), osmium (Os), and rhenium (Re). However, organic luminescent materials in the present invention are not limited to those mentioned above.

The organic luminescent material may be a fluorescent material or a phosphorescent material, but in order to achieve high color purity, a fluorescent material is preferred. Among them, a pyrromethene derivative may be suitably used as the organic luminescent material described above, because this gives a high fluorescence quantum yield and exhibits better durability. A compound of the general formula (2) is more preferred organic luminescent material:

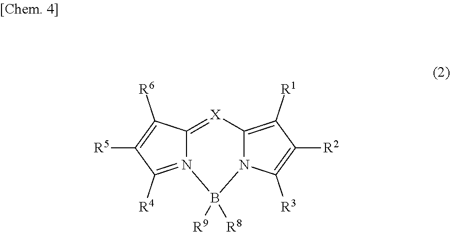

When the component (A) contains a compound of the general formula (2) as the organic luminescent material, X is C—R⁷ or N in the general formula (2). Each of R¹ to R⁹, which may be the same as or different from one another, is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, a phosphine oxide group, and a fused ring or an aliphatic ring each formed between adjacent substituents.

In all of the groups above, hydrogen may be deuterium. This also applies to the compounds or partial structures thereof described below. In the following description, for example, a substituted or unsubstituted aryl group having a carbon number of 6 to 40 means an aryl group in which the number of all carbons is from 6 to 40 including the number of carbons contained in a substituent substituted on the aryl group, and the same applies to other substituents of which carbon number is specified.

In all of the groups above, when the group is substituted, the substituent is preferably an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group. Furthermore, specific substituents that are preferred in the description of each substituent are preferred. These substituents may further be substituted with the above-described substituent.

The word “unsubstituted” in the phrase “substituted or unsubstituted” refers to substitution with a hydrogen atom or a deuterium atom. The same definition applies to “substituted or unsubstituted” in the compounds or their partial structures described below.

Among all of the groups above, the alkyl group is, for example, a saturated aliphatic hydrocarbon group such as a methyl group, an ethyl group, an n-propyl group, an isopropyl group, an n-butyl group, a sec-butyl group and a tert-butyl group, which may or may not have a substituent. The additional substituent in the case of being substituted is not particularly limited and includes, for example, an alkyl group, halogen, an aryl group, and a heteroaryl group, and this is a common feature in the following description. The carbon number of the alkyl group is not particularly limited but in view of easy availability and cost, is preferably from 1 to 20, and more preferably from 1 to 8.

The cycloalkyl group is, for example, a saturated alicyclic hydrocarbon group such as a cyclopropyl group, a cyclohexyl group, a norbornyl group and an adamantyl group, which may or may not have a substituent. The carbon number of the alkyl group moiety is not particularly limited but is preferably from 3 to 20.

The heterocyclic group is, for example, an aliphatic ring having an atom other than carbon in the ring, such as pyrane ring, piperidine ring and cyclic amide, which may or may not have a substituent. The carbon number of the heterocyclic group is not particularly limited but is preferably from 2 to 20.

The alkenyl group is, for example, an unsaturated aliphatic hydrocarbon group containing a double bond, such as a vinyl group, an allyl group and a butadienyl group, which may or may not have a substituent. The carbon number of the alkenyl group is not particularly limited but is preferably from 2 to 20.

The cycloalkenyl group is, for example, an unsaturated alicyclic hydrocarbon group containing a double bond, such as a cyclopentenyl group, a cyclopentadienyl group and a cyclohexenyl group, which may or may not have a substituent. The carbon number of the cycloalkenyl group is not particularly limited but is preferably from 3 to 20.

The alkynyl group is, for example, an unsaturated aliphatic hydrocarbon group containing a triple bond, such as an ethynyl group, which may or may not have a substituent. The carbon number of the alkynyl group is not particularly limited but is preferably from 2 to 20.

The alkoxy group is, for example, a functional group to which an aliphatic hydrocarbon group is bonded through an ether bond, such as a methoxy group, an ethoxy group and a propoxy group, and the aliphatic hydrocarbon group may or may not have a substituent. The carbon number of the alkoxy group is not particularly limited but is preferably from 1 to 20.

An alkylthio group is a functional group in which the oxygen atom of the ether bond of the alkoxy group is substituted with a sulfur atom. The hydrocarbon group in the alkylthio group may or may not have a substituent. The carbon number of the alkylthio group is not particularly limited but is preferably from 1 to 20.

The aryl ether group is, for example, a functional group to which an aromatic hydrocarbon group is bonded through an ether bond, such as a phenoxy group, and the aromatic hydrocarbon group may or may not have a substituent. The carbon number of the aryl ether group is not particularly limited but is preferably from 6 to 40.

An aryl thioether group is a functional group in which the oxygen atom of the ether bond of the aryl ether group is substituted with a sulfur atom. The aromatic hydrocarbon group in the aryl thioether group may or may not have a substituent. The carbon number of the aryl thioether group is not particularly limited but is preferably from 6 to 40.

The aryl group is, for example, an aromatic hydrocarbon group such as a phenyl group, a biphenyl group, a terphenyl group, a naphthyl group, a fluorenyl group, a benzofluorenyl group, a dibenzofluorenyl group, a phenanthryl group, an anthracenyl group, a benzophenanthryl group, a benzoanthracenyl group, a chrysenyl group, a pyrenyl group, a fluoranthenyl group, a triphenylenyl group, a benzofluoranthenyl group, a dibenzoanthracenyl group, a perylenyl group and a helicenyl group. Among them, a phenyl group, a biphenyl group, a terphenyl group, a naphthyl group, a fluorenyl group, a phenanthryl group, an anthracenyl group, pyrenyl group, a fluoranthenyl group, and a triphenylenyl group are preferred. The aryl group may or may not have a substituent. The carbon number of the aryl group is not particularly limited but is preferably from 6 to 40, and more preferably from 6 to 30.

In the case where R¹ to R⁹ are a substituted or unsubstituted aryl group, the aryl group is preferably a phenyl group, a biphenyl group, a terphenyl group, a naphthyl group, a fluorenyl group, a phenanthryl group, or an anthracenyl group, more preferably a phenyl group, a biphenyl group, a terphenyl group, or a naphthyl group, still more preferably a phenyl group, a biphenyl group, or a terphenyl group, yet still more preferably a phenyl group.

In the case where each substituent is further substituted with an aryl group, the aryl group is preferably a phenyl group, a biphenyl group, a terphenyl group, a naphthyl group, a fluorenyl group, a phenanthryl group, or an anthracenyl group, more preferably a phenyl group, a biphenyl group, a terphenyl group, or a naphthyl group, particularly preferably a phenyl group.

The heteroaryl group is, for example, a cyclic aromatic group having one or two or more atoms other than carbon in the ring, such as a pyridyl group, a furanyl group, a thienyl group, a quinolinyl group, an isoquinolinyl group, a pyrazinyl group, a pyrimidyl group, a pyridazinyl group, a triazinyl group, a naphthyridinyl group, a cinnolinyl group, a phthalazinyl group, a quinoxalinyl group, a quinazolinyl group, a benzofuranyl group, a benzothienyl group, an indolyl group, a dibenzofuranyl group, a dibenzothienyl group, a carbazolyl group, a benzocarbazolyl group, a carbolinyl group, an indolocarbazolyl group, a benzofurocarbazolyl group, a benzothienocarbazolyl group, dihydroindenocarbazolyl group, benzoquinolinyl group, an acridinyl group, a dibenzoacridinyl group, a benzimidazolyl group, an imidazopyridyl group, a benzoxazolyl group, a benzothiazolyl group, or a phenanthrolinyl group. It is noted that the naphthyridinyl group is any one of 1,5-naphthyridinyl group, 1,6-naphthyridinyl group, 1,7-naphthyridinyl group, 1,8-naphthyridinyl group, 2,6-naphthyridinyl group, 2,7-naphthyridinyl group. The heteroaryl group may or may not have a substituent. The carbon number of the heteroaryl group is not particularly limited but is preferably from 2 to 40, and more preferably from 2 to 30.

In the case where R¹ to R⁹ are a substituted or unsubstituted heteroaryl group, the heteroaryl group is preferably a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group, more preferably a pyridyl group, a furanyl group, a thienyl group, or a quinolinyl group, particularly preferably a pyridyl group.

In the case where each substituent is further substituted with a heteroaryl group, the heteroaryl group is preferably a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group, more preferably a pyridyl group, a furanyl group, a thienyl group, or a quinolinyl group, particularly preferably a pyridyl group.

Halogen represents an atom selected from fluorine, chlorine, bromine and iodine. The carbonyl group, carboxyl group, oxycarbonyl group and carbamoyl group may or may not have a substituent. The substituent includes, for example, an alkyl group, a cycloalkyl group, an aryl group, and a heteroaryl group, and these substituents may be further substituted.

An amino group represents a substituted or unsubstituted amino group. The amino group may or may not have a substituent, and when the amino group is substituted, the substituent is, for example, an aryl group, a heteroaryl group, a linear alkyl group, or a branched alkyl group. As the aryl group and heteroaryl group, a phenyl group, a naphthyl group, a pyridyl group, and quinolinyl group are preferred. These groups may be further substituted. The carbon number is not particularly limited but is preferably from 2 to 50, more preferably from 6 to 40, and particularly preferably from 6 to 30.

The silyl group represents, for example, an alkylsilyl group such as a trimethylsilyl group, a triethylsilyl group, a tert-butyldimethylsilyl group, a propyldimethylsilyl group and a vinyldimethylsilyl group, or an arylsilyl group such as a phenyldimethylsilyl group, a tert-butyldiphenylsilyl group, a triphenylsilyl group or a trinaphthylsilyl group. The substituent on the silicon atom may further be substituted. The carbon number of the silyl group is not particularly limited but is preferably from 1 to 30.

The siloxanyl group represents a silicon compound group via an ether bond, such as trimethylsiloxanyl group. The substituent on the silicon atom may further be substituted. The boryl group is a substituted or unsubstituted boryl group. The boryl group may or may not have a substituent, and when the boryl group is substituted, the substituent is, for example, an aryl group, a heteroaryl group, a linear alkyl group, a branched alkyl group, an aryl ether group, an alkoxy group, or a hydroxyl group. Among them, an alkyl group and an aryl ether group are preferable. The phosphine oxide group is a group represented by —P(═O)R¹⁰R¹¹. R¹⁰R¹¹ is selected from the same group as those for R¹ to R⁹.

Further, a fused ring and an aliphatic ring each formed between adjacent substituents means that arbitrary adjacent two substituents (for example, R¹ and R² in the general formula (2)) may be bonded each other to form a conjugated or non-conjugated cyclic skeleton. As constituent elements, such a fused ring or aliphatic ring may include an element selected from the group consisting of nitrogen, oxygen, sulfur, phosphorus and silicon, in addition to carbon. The above fused ring or aliphatic ring may be further fused with another ring.

The compound of the general formula (2) exhibits a high fluorescence quantum yield and provides an emission spectrum with narrow peak full width at half maximum, so that both efficient color conversion and high color purity can be achieved, and the durability can be further improved.

Furthermore, various properties and physical properties such as light emission efficiency, color purity, thermal stability, photostability and dispersibility can be adjusted by introducing an appropriate substituent into an appropriate position of the compound of the general formula (2). For example, compared with the case where all of R¹, R³, R⁴, and R⁶ are hydrogen atoms, when at least one of R¹, R³, R⁴, and R⁶ is a substituted or unsubstituted alkyl group, a substituted or unsubstituted aryl group, or a substituted or unsubstituted heteroaryl group, better thermal stability and photostability are exhibited.

Preferred examples of R¹, R³, R⁴, and R⁶ are methyl group, ethyl group, isopropyl group, tert-butyl group, phenyl group, biphenyl group, terphenyl group, naphthyl group, pyridyl group, and quinolinyl group. Each of R¹, R³, R⁴, and R⁶ may be the same as or different from one another.

Each of R² and R⁵ is preferably a hydrogen atom, an alkyl group, a carbonyl group, an oxycarbonyl group or an aryl group. Among them, an alkyl group or a hydrogen atom is preferable in view of thermal stability, and a hydrogen atom is more preferable since it is easy to obtain a narrow full width at half maximum in the emission spectrum.

Each of R⁸ and R⁹ is preferably an alkyl group, an aryl group, a heteroaryl group, fluorine, a fluorine-containing alkyl group, a fluorine-containing heteroaryl group, or a fluorine-containing aryl group. Among them, each of R⁸ and R⁹ is more preferably fluorine or a fluorine-containing aryl group for the reason that the compound is stable against excitation light and a higher fluorescence quantum yield is obtained. When R⁸ and R⁹ each are fluorine or a fluorine-containing aryl group, the electron-donating properties of the compound of the general formula (2) are weaken, so that the electronic interaction with the component (C) can be prevented, providing high fluorescence quantum yield.

In order to prevent reduction of the fluorescence quantum yield of the component (A) due to the component (C), at least one of R¹ to R⁷ is preferably an appropriately bulky substituent. The color conversion composition according to the embodiment of the present invention contains the component (A) and the component (C) in the same layer. Therefore, in the layer of the color conversion composition, collisions between the components (A) and (C) may occur due to thermal diffusion. When the component (C) and an excited luminescent material collide with each other, excitation energy of the luminescent material may be transferred to a molecule of the component (C), and the excited luminescent material may be deactivated, resulting in reduction of the fluorescence quantum yield of the component (A). In the present invention, when X in the general formula (2) is C—R⁷, and at least one of R¹ to R⁷ is an appropriately bulky substituent, such reduction of the fluorescence quantum yield of the component (A) can be prevented. At least one of R², R⁵, and R⁷ is more preferably an appropriately bulky substituent, and all R², R⁵, and R⁷ are particularly preferably appropriately bulky substituents.

The appropriately bulky substituent for R² and R⁵ may be, for example, an alkyl group, a cycloalkyl group, a heterocyclic group, an alkenyl group, a cycloalkenyl group, an alkynyl group, an alkoxy group, an alkylthio group, an aryl ether group, an aryl thioether group, an aryl group, a heteroaryl group, a carbonyl group, a carboxyl group, an oxycarbonyl group, an ester group, a carbamoyl group, an amino group, a nitro group, a silyl group, a siloxanyl group, a boryl group, or a phosphine oxide group. Among them, an alkyl group, a cycloalkyl group, an aryl group, and an ester group are more preferable.

A preferred example of the appropriately bulky substituent for R⁷ is the structure of the following general formula (3). That is, when X in the general formula (2) is C—R⁷, the R⁷ is preferably a group of the general formula (3).

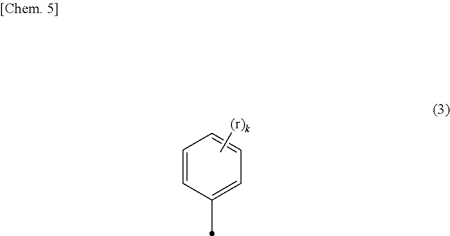

In the general formula (3), r is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, and a phosphine oxide group. k is an integer of 1 to 3. When k is 2 or more, r may be the same as or different from one another.

r in the general formula (3) is preferably a substituted or unsubstituted aryl group. Especially among aryl groups, preferable examples include a phenyl group and a naphthyl group. The aryl group may further be substituted with one or more groups selected from the group consisting of an alkyl group, a heterocyclic group, an alkenyl group, a hydroxyl group, an alkoxy group, an aryl ether group, an aryl group, a heteroaryl group, halogen, a cyano group, a carboxyl group, an ester group, an oxycarbonyl group, and an alkoxy group.

Furthermore, in the general formula (3), at least one r is preferably substituted with an alkyl group or an aryl group. In this case, particularly preferable examples of the alkyl group include a methyl group, an ethyl group, and a tert-butyl group.

In the case where r is an aryl group in the general formula (3), k in the general formula (3) is preferably 1 or 2, and more preferably 2, in view of further preventing reduction of the fluorescence quantum yield of the component (A) due to the component (C).

In addition, from the viewpoint of controlling the fluorescence wavelength or absorption wavelength or increasing the compatibility with a solvent, r in the general formula (3) is preferably a substituted or unsubstituted alkyl group, a substituted or unsubstituted alkoxy group, or halogen. Among them, a methyl group, an ethyl group, a tert-butyl group, and a methoxy group are more preferable. In view of dispersibility, a tert-butyl group or a methoxy group is particularly preferred as the r. In this case, quenching due to aggregation of molecules to each other can be prevented.

In another aspect of the compound of the general formula (2), at least one of R¹ to R⁷ is preferably an electron withdrawing group. In particular, it is preferred that (1) at least one of R¹ to R⁶ is an electron withdrawing group, (2) R⁷ is an electron withdrawing group, or (3) at least one of R¹ to R⁶ is an electron withdrawing group and R⁷ is an electron withdrawing group.

There are two reasons for this. The first reason is to further improve the effect of the component (C) on the durability against light of the color conversion composition. That is, introduction of an electron withdrawing group into a pyrromethene skeleton makes it possible to greatly decrease the electron density of the pyrromethene skeleton and to reduce the reaction rate between the compound having a pyrromethene skeleton and singlet oxygen. This makes the reaction rate at which singlet oxygen is deactivated by the component (C) faster than the reaction rate at which the component (A) is oxidized by singlet oxygen, so that the effect of improving the durability against light of the color conversion composition by the component (C) is more significant.

The second reason is to prevent the components (A) and (C) from forming a charge transfer complex. That is, the component (C) used in the color conversion composition of the present invention has an electron withdrawing group and thus tends to act as an acceptor and therefore may interact with an electron-donating compound, causing charge transfer. Examples of the effect of charge transfer include a reduction in color reproducibility due to the color-converted emission wavelength by the luminescent material being changed to longer wavelength, and a reduction in the fluorescence quantum yield of the luminescent material due to a reduction in light emission intensity. To suppress these effects, it is effective to introduce an electron withdrawing group into the luminescent material as well. Thus, electrostatic repulsion can prevent the components (A) and (C), which are luminescent materials, from approaching each, or reduce the HOMO (Highest occupied molecular orbital) level of the luminescent material to suppress charge transfer from the component (A) to the component (C).

The electron withdrawing group, otherwise called an electron-accepting group, is, in the organic electron theory, an atomic group that draws electrons by an inductive effect or a resonance effect from an atomic group on which the group is substituted. The electron withdrawing group includes a group in which the value of a substituent constant (σp (para)) of Hammett's rule is positive. The substituent constant (σp (para)) of Hammett's rule can be quoted from KAGAKU BINRAN (Chemical Handbook), Basic Edition, 5th rev., (page: II-380). A phenyl group takes a positive value in some examples as described above, but a phenyl group is not encompassed by the electron withdrawing group in the present invention.

Examples of the electron withdrawing group include —F (σp: +0.20), —Cl (σp: +0.28), —Br (σp: +0.30), —I (σp: +0.30), —CO₂R¹² (σp: +0.45 when R¹² is an ethyl group), —CONH² (σp: +0.38), —COR¹² (σp: +0.49 when R¹² is a methyl group), —CF₃ (σp: +0.51), —SO₂R¹² (σp: +0.69 when R¹² is a methyl group), and —NO₂ (σp: +0.81). Each R¹² independently is a hydrogen atom, a substituted or unsubstituted aromatic hydrocarbon group having a ring-forming carbon number of 6 to 30, a substituted or unsubstituted heterocyclic group having a ring-forming carbon number of 5 to 30, a substituted or unsubstituted alkyl group having a carbon number of 1 to 30, or a substituted or unsubstituted cycloalkyl group having a carbon number of 1 to 30. Specific examples of each of these groups are the same as those described above.

The electron withdrawing group is preferably fluorine, a fluorine-containing aryl group, a fluorine-containing heteroaryl group, a fluorine-containing alkyl group, a substituted or unsubstituted acyl group, a substituted or unsubstituted ester group, a substituted or unsubstituted amide group, a substituted or unsubstituted sulfonyl group, or a cyano group, because they are unlikely to be decomposed chemically.

The electron withdrawing group is more preferably a fluorine-containing alkyl group, a substituted or unsubstituted acyl group, a substituted or unsubstituted ester group, or a cyano group, because they prevent concentration quenching, which leads to an effect of enhancing the emission quantum yield. Particularly preferable electron withdrawing groups are substituted or unsubstituted ester groups.

In the compound of the general formula (2), more preferably, at least one of R¹ to R⁶ is an electron withdrawing group, X is C—R⁷, and the R⁷ is a group of the general formula (3).

Examples of the compound represented by the general formula (2) are illustrated below, but the compound is not limited thereto.

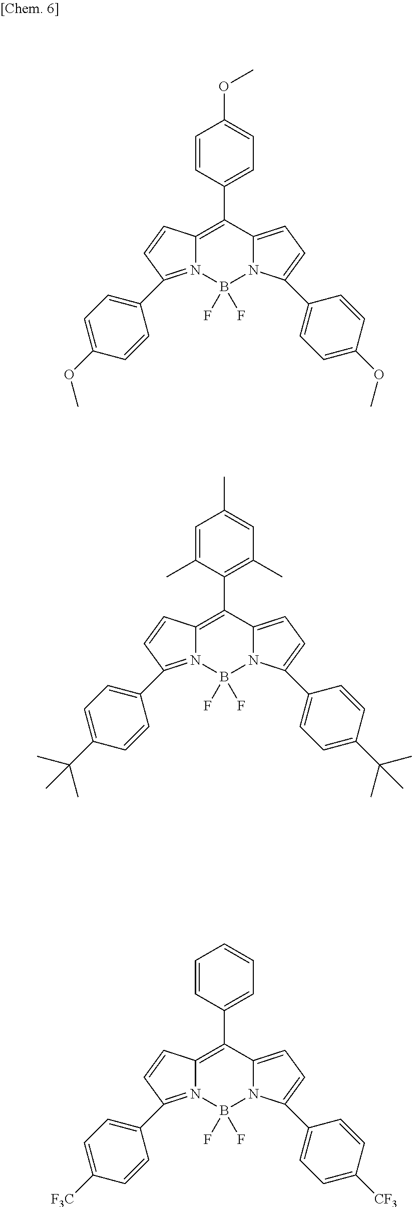

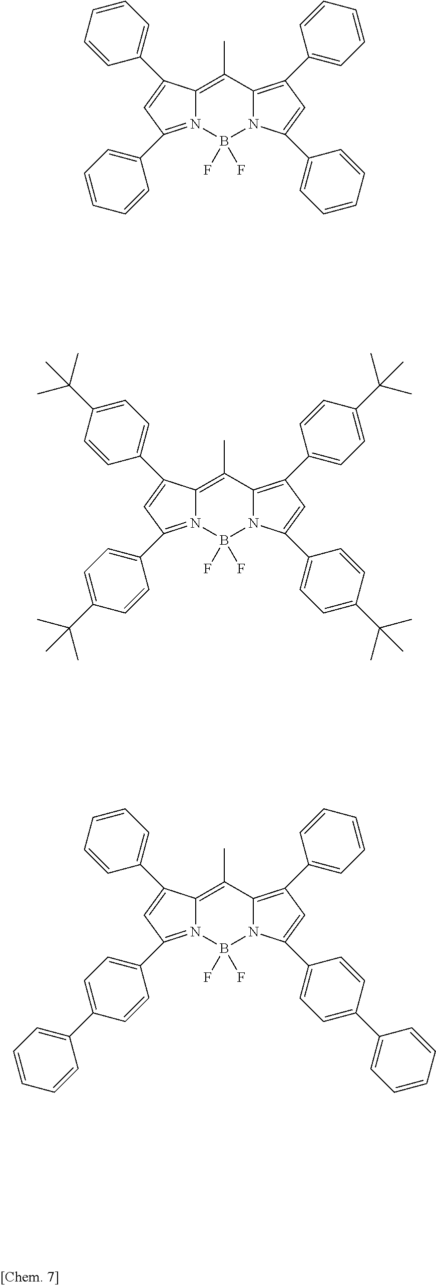

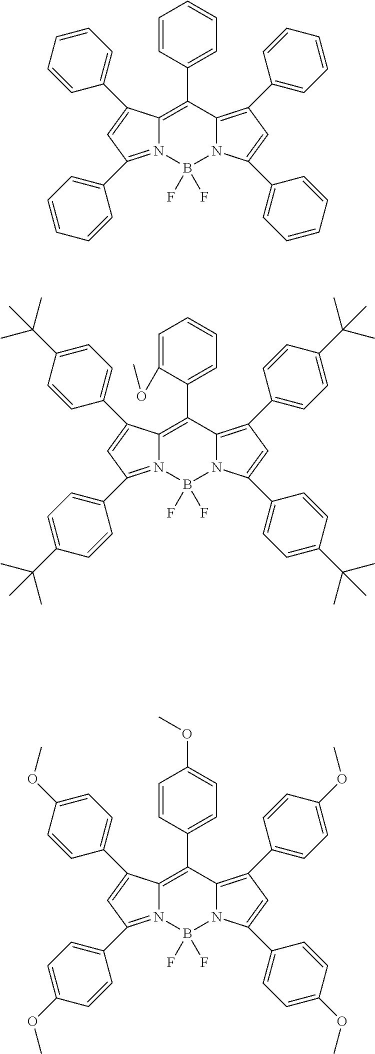

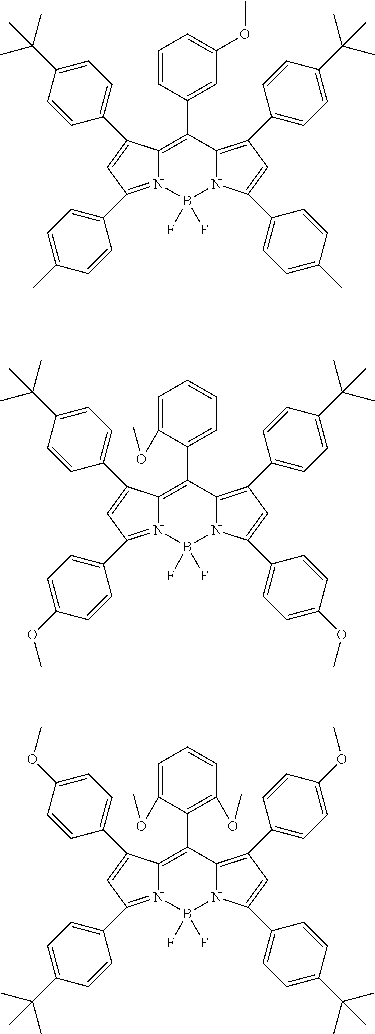

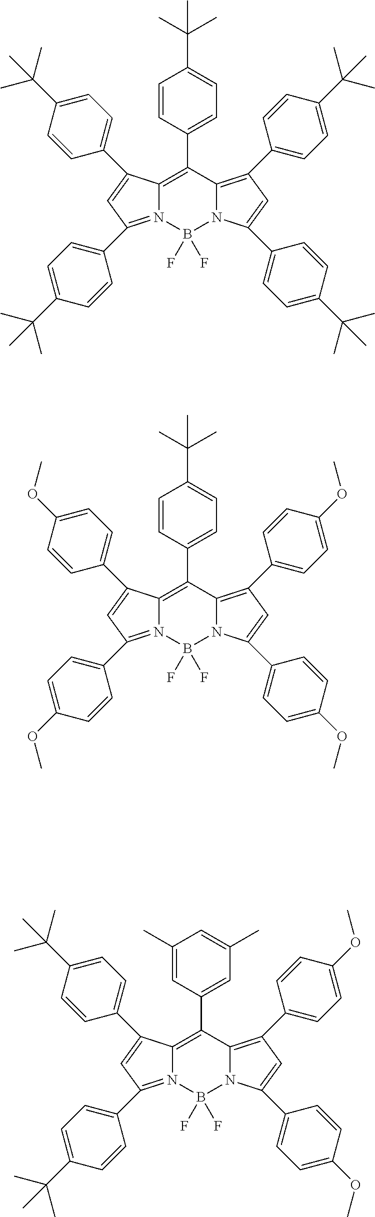

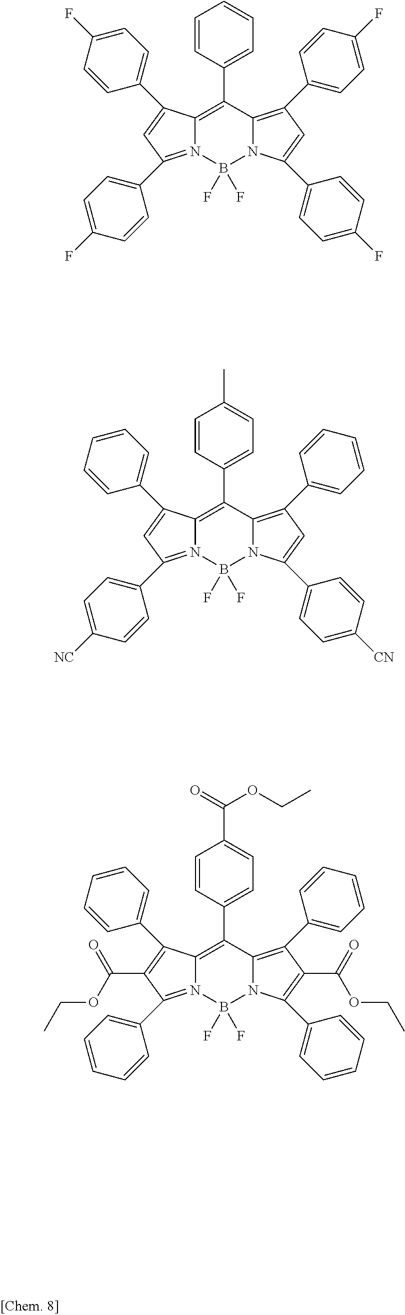

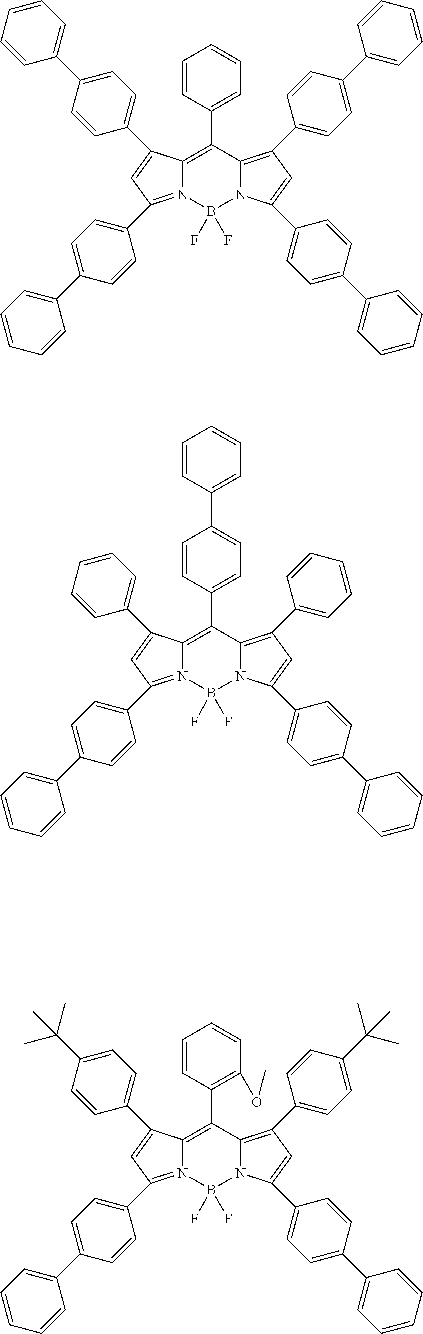

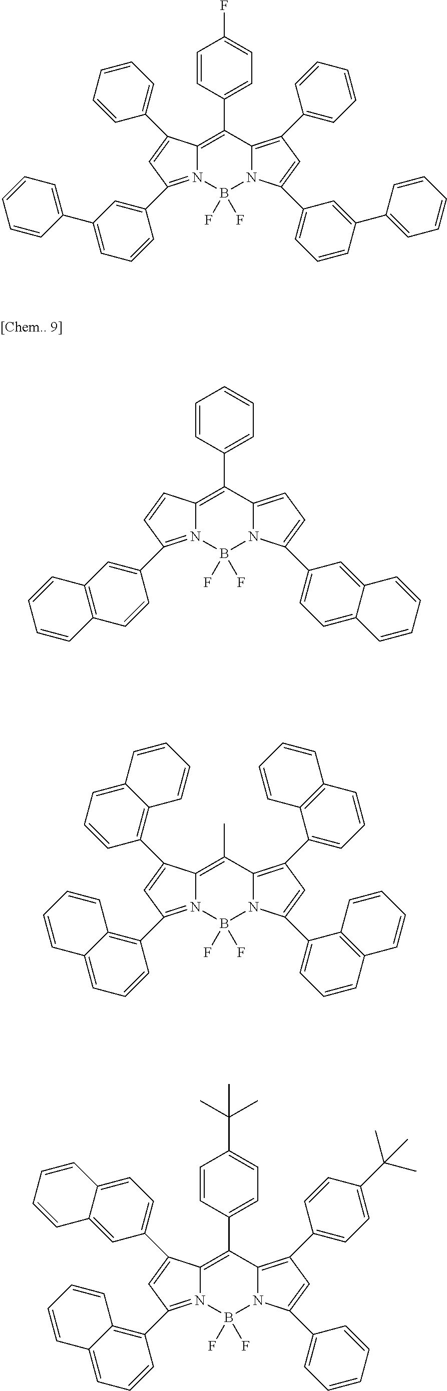

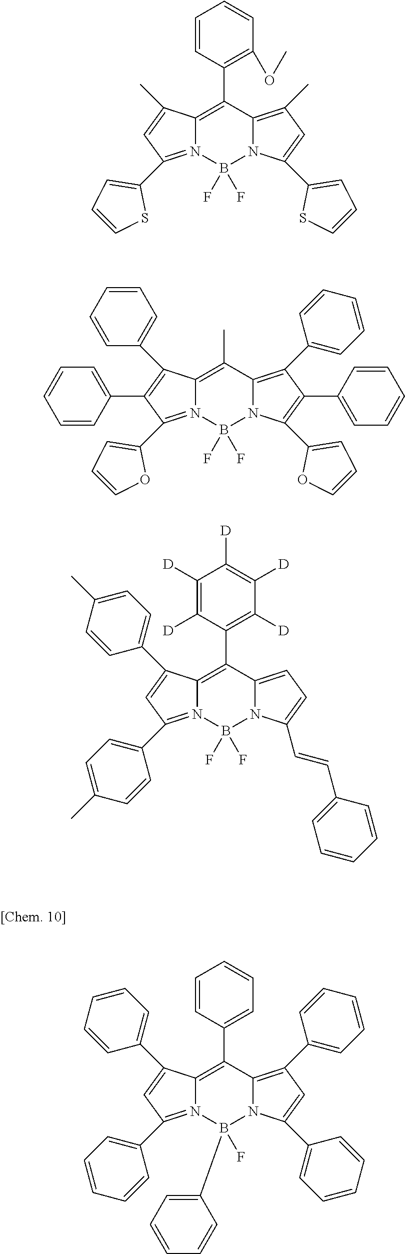

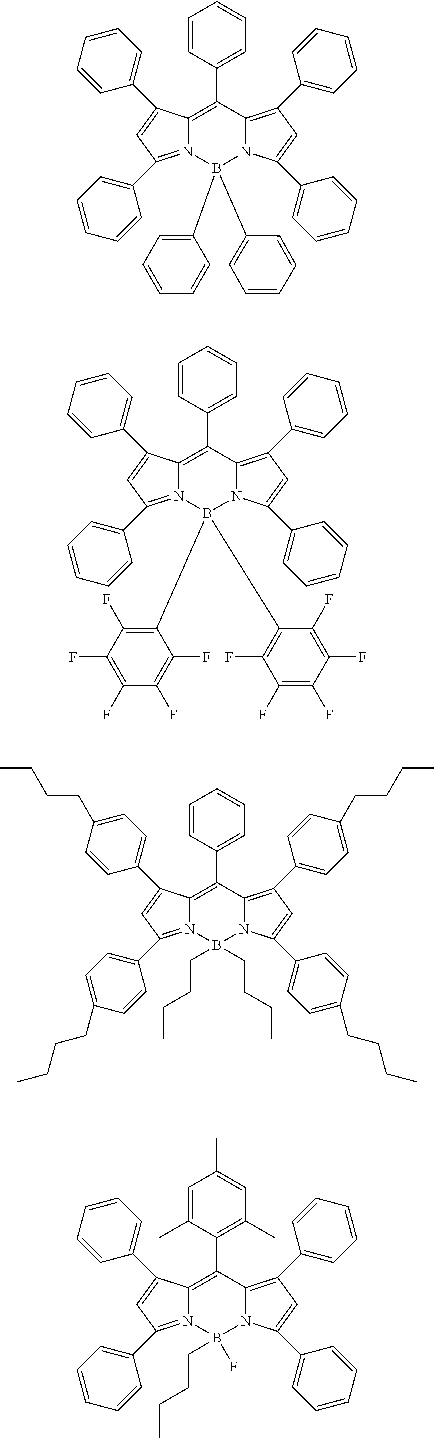

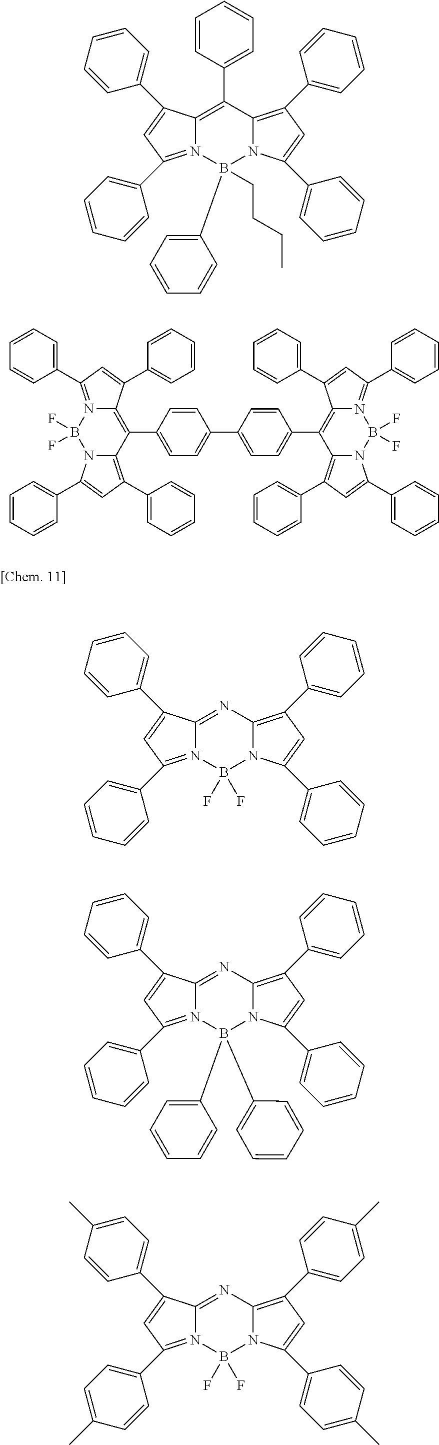

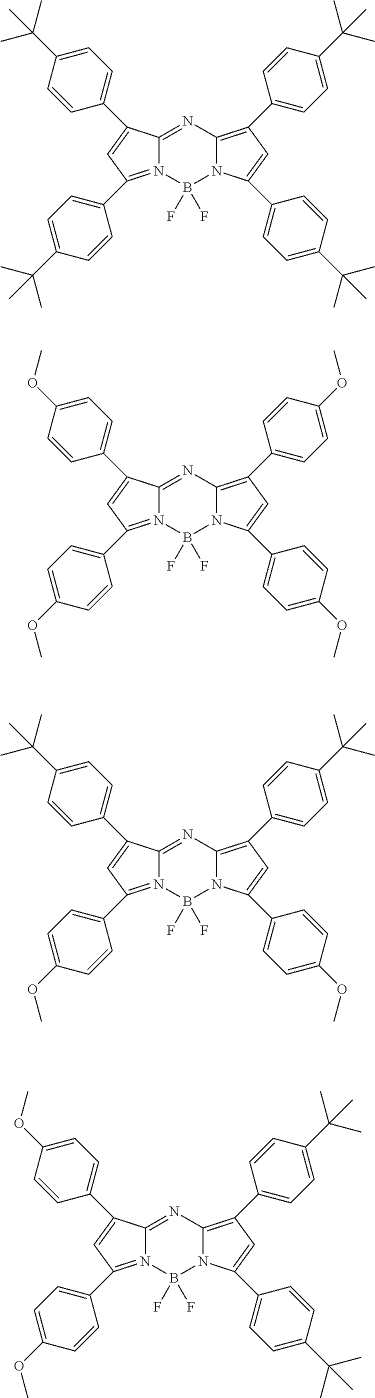

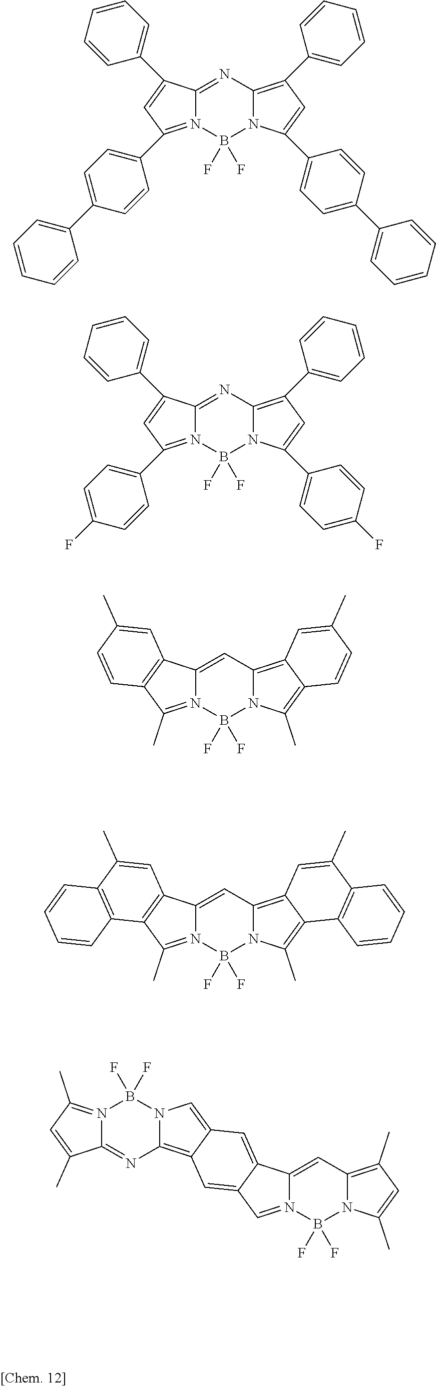

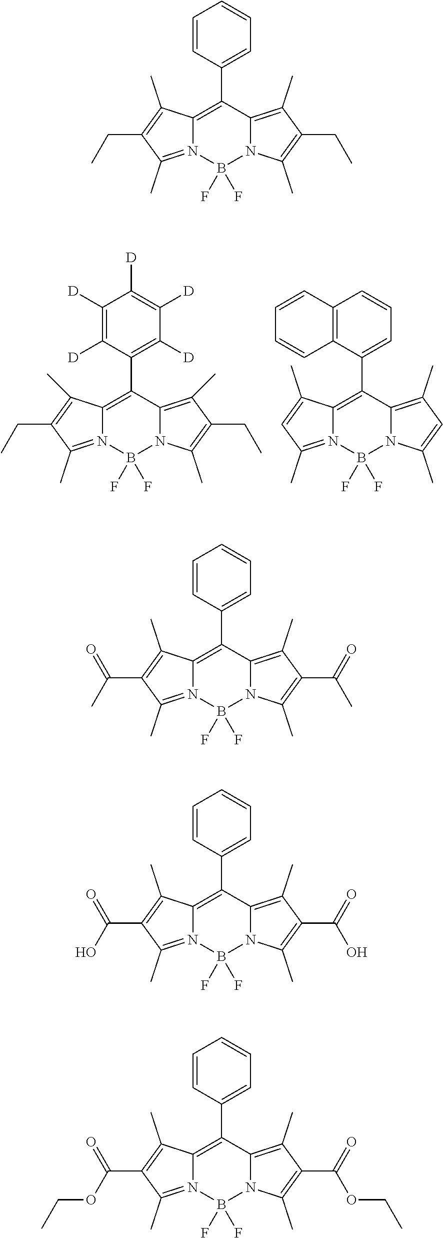

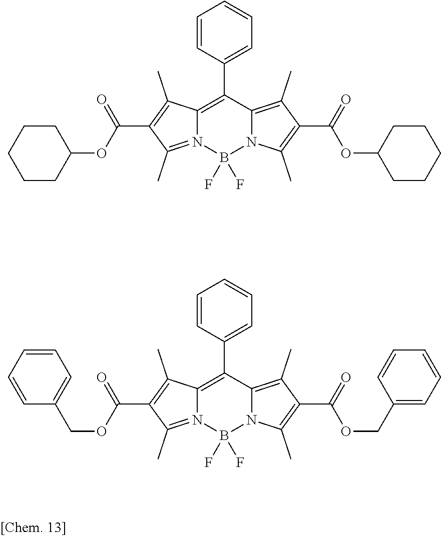

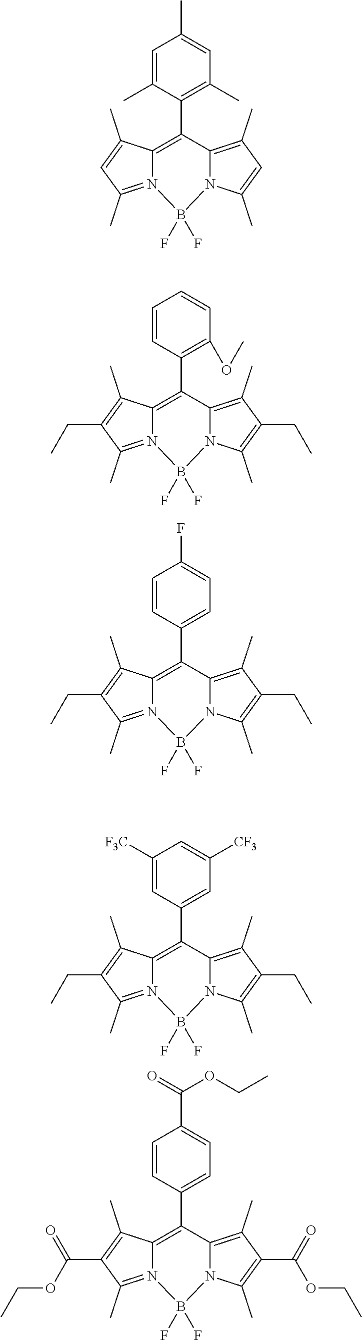

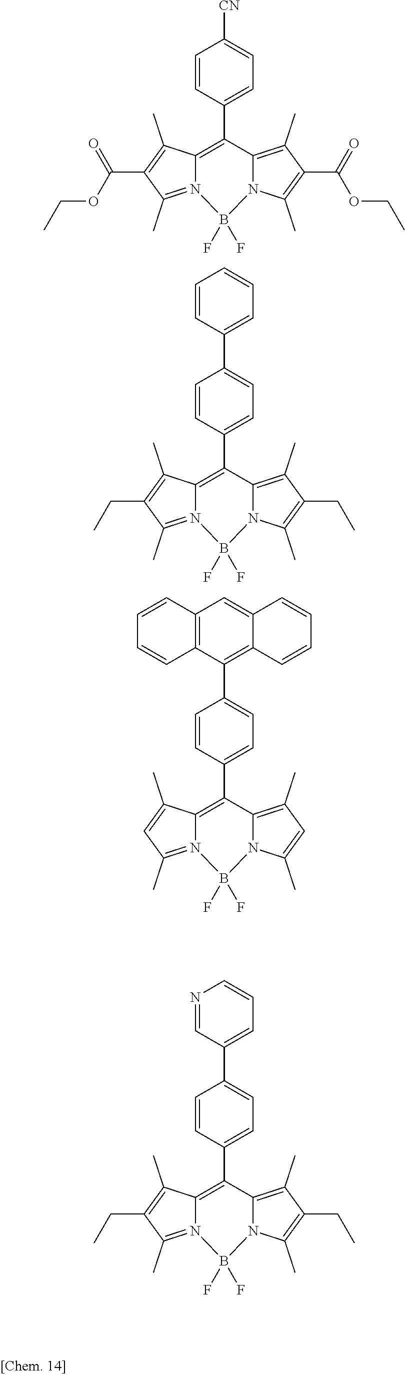

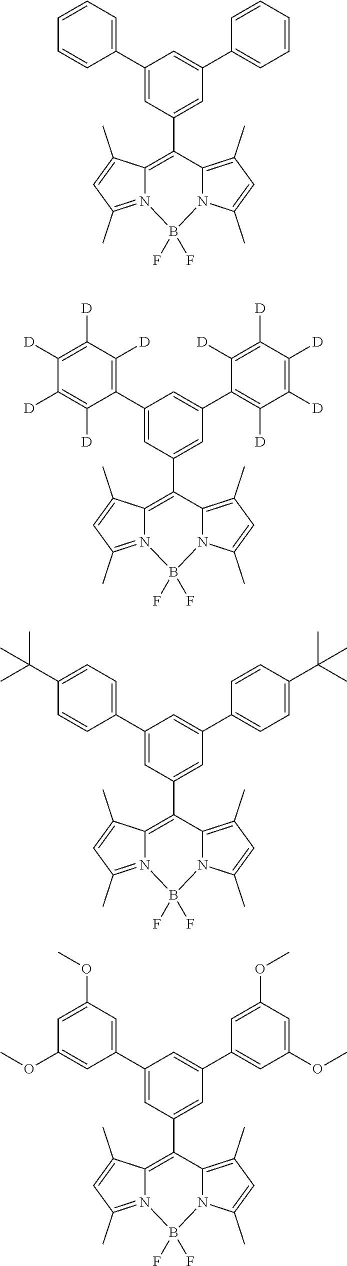

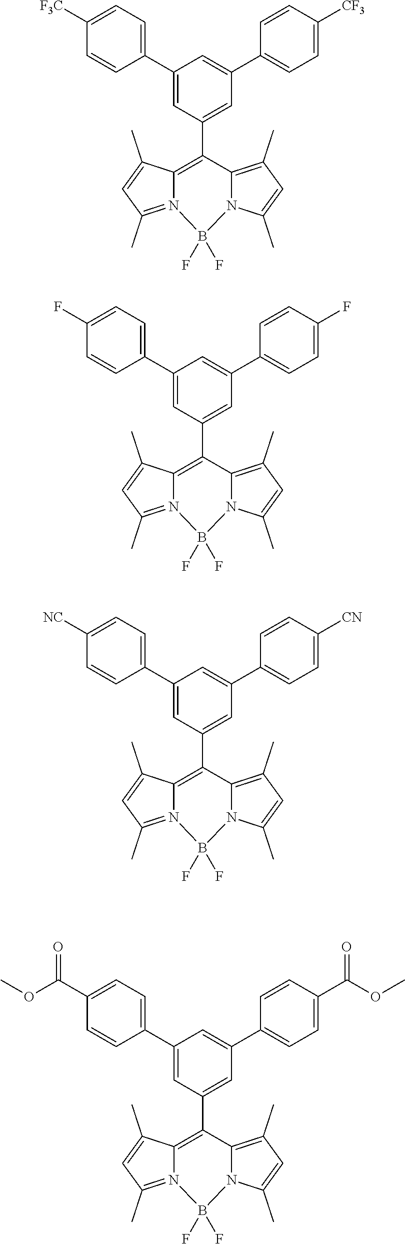

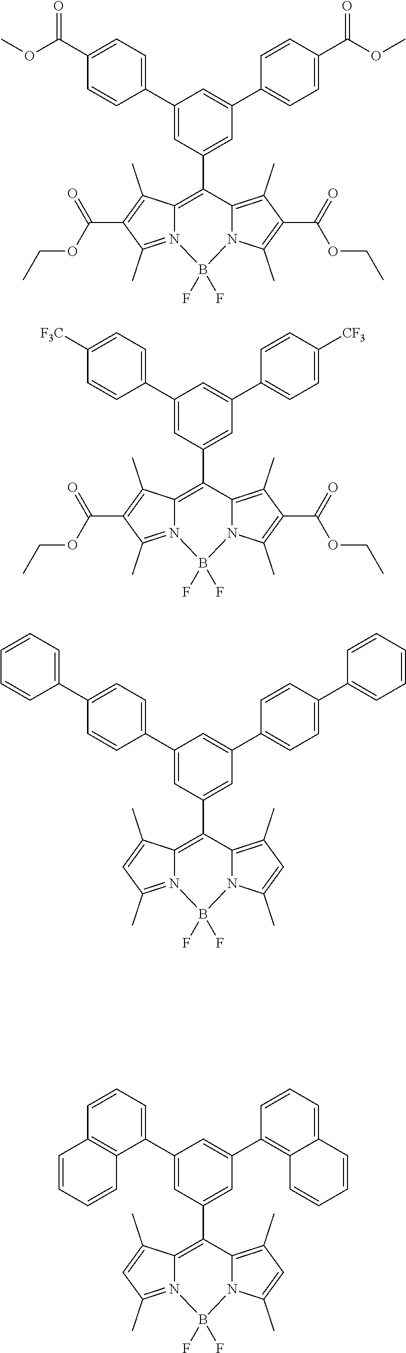

The compound of the general formula (2) can be synthesized by the method described, for example, in JP-T-8-509471 or JP-A-2000-208262. That is, a target pyrromethene-based metal complex can be obtained by reacting a pyrromethene compound with a metal salt in the co-presence of a base. Regarding the synthesis of pyrromethene-boron fluoride complexes, the compound of the general formula (2) can be synthesized by referring to the methods described in J. Org. Chem., vol. 64, No. 21, pp. 7813-7819 (1999) and Angew. Chem., Int. Ed. Engl., vol. 36, pp. 1333-1335 (1997), for example. The method includes, for example, a method of heating compounds of the following general formulae (4) and (5) in 1,2-dichloroethane in the presence of phosphorus oxychloride, followed by reaction with a compound of the following general formula (6) in 1,2-dichloroethane in the presence of triethylamine, thereby obtaining compounds of the general formula (2), but the present invention is not limited thereto. In the formulae, R¹ to R⁹ are the same as above. J is halogen.

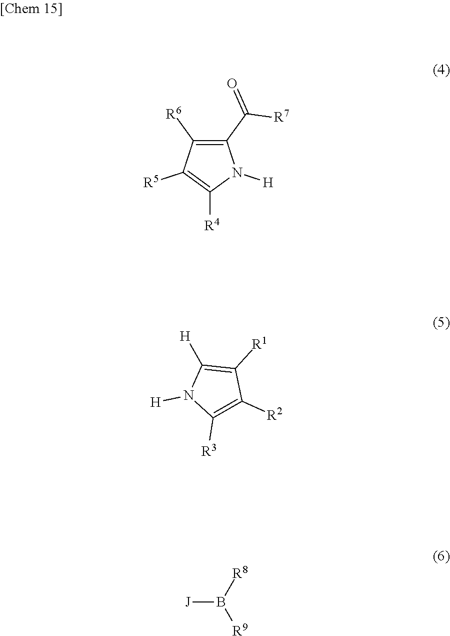

Furthermore, methods of introducing an aryl group or a heteroaryl group includes, but are not limited to, a method of producing a carbon-carbon bond by using a coupling reaction of a halogenated derivative with a boronic acid or a boronic ester derivative, but the present invention is not limited thereto. Similarly, methods for introducing an amino group or a carbazolyl group include a method of producing a carbon-nitrogen bond by using a coupling reaction of a halogenated derivative with an amine or carbazole derivative in the presence of a metal catalyst such as palladium, but the present invention is not limited thereto.

The color conversion composition according to the embodiment of the present invention may appropriately contain another compound, if needed, other than the compound of the general formula (2). For example, the composition may contain an assist dopant such as rubrene to further enhance the energy transfer efficiency from excitation light to the compound of the general formula (2). In the case of intending to add an emission color other than the emission color of the compound of the general formula (2), the above-described organic luminescent material, or a known luminescent material such as an inorganic fluorescent substance, a fluorescent pigment, a fluorescent dye, or a quantum dot may be added.

Examples of the organic luminescent material other than the compound of the general formula (2) are illustrated below, but the present invention is not limited thereto.

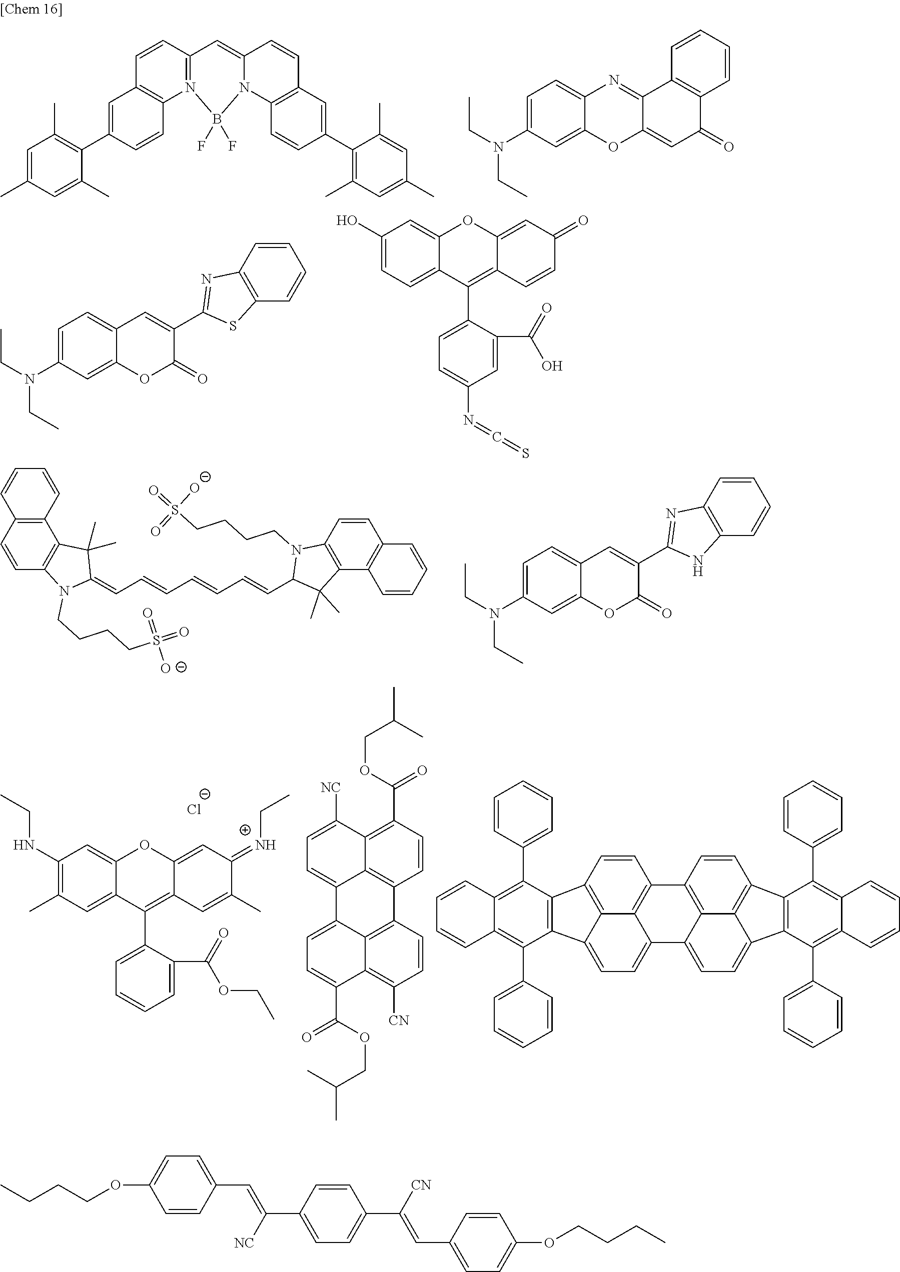

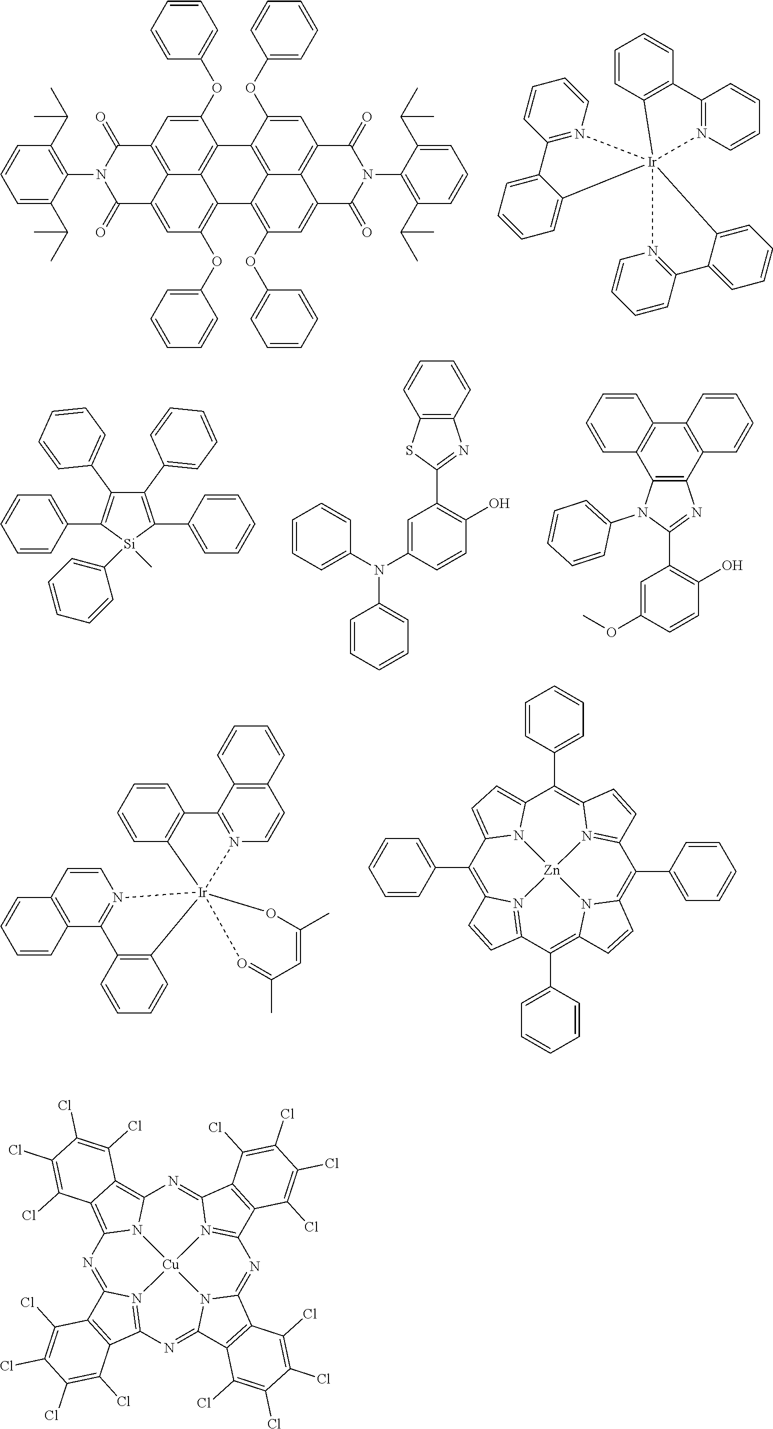

In the color conversion composition according to the embodiment of the present invention, the component (A) preferably contains a luminescent material emitting light having a peak wavelength observed in the region of 500 nm to less than 580 nm by use of excitation light having a wavelength of 400 nm to 500 nm (hereinafter, referred to as “luminescent material (a)”). Hereinafter, emission of light having a peak wavelength observed in the region of 500 nm to less than 580 nm is referred to as “green emission”. In general, excitation light having lager energy is more likely to cause decomposition of a material, but the excitation energy of excitation light having a wavelength of 400 nm to 500 nm has relatively small excitation energy, and green emission having a good color purity is therefore obtained without causing decomposition of a luminescent material (a) in the color conversion composition.

Further, in the color conversion composition according to the embodiment of the present invention, the component (A) preferably contains at least one of the following luminescent materials (a) and (b). As mentioned above, the luminescent material (a) is a luminescent material that emits light having a peak wavelength of 500 nm to less than 580 nm by use of excitation light having a wavelength of 400 nm to 500 nm. The luminescent material (b) is a luminescent material that emits light having a peak wavelength observed in the region of 580 nm to 750 nm when excited by at least one of excitation light having a wavelength of 400 nm to 500 nm and light emitted by the luminescent material (a). Hereinafter, emission of light having a peak wavelength observed in the region of 580 nm to 750 nm is referred to as “red emission”.

Part of the excitation light having a wavelength of 400 nm to 500 nm partially transmits through the color conversion sheet according to the embodiment of the present invention, and thus in the case of using a blue LED having a sharp emission peak, each of blue, green and red colors exhibits an emission spectrum in a sharp profile, making it possible to obtain white light with good color purity. As a result, particularly in a display, more vivid colors and a larger color gamut can be efficiently produced. In the lighting applications, compared with a currently prevailing white LED fabricated by combining a blue LED and a yellow phosphor, the light emission characteristics particularly in the green and red regions are improved, and therefore a preferable white light source with enhanced color rendering properties can be obtained.

The luminescent material (a) may be, for example, a coumarin derivative such as coumarin 6, coumarin 7 or coumarin 153, a cyanine derivative such as indocyanine green, a fluorescein derivative such as fluorescein, fluorescein isothiocyanate or carboxyfluorescein diacetate, a phthalocyanine derivative such as phthalocyanine green, a perylene derivative such as diisobutyl-4,10-dicyanoperylene-3,9-dicarboxylate, a pyrromethene derivative, a stilbene derivative, an oxazine derivative, a naphthalimide derivative, a pyrazine derivative, a benzimidazole derivative, a benzoxazole derivative, a benzothiazole derivative, an imidazopyridine derivative, an azole derivative, a compound having a fused aryl ring, such as anthracene, or a derivative thereof, an aromatic amine derivative, or an organic metal complex compound. The component (A) may contain two or more of them as the luminescent material (a).

Among these compounds, a pyrromethene derivative gives a high fluorescence quantum yield, has good color purity durability, and is therefore a particularly suitable compound. Among the pyrromethene derivatives, a compound of the general formula (2) exhibits light emission with high color purity and is thus preferred.

The luminescent material (b) may be, for example, a cyanine derivative such as 4-dicyanomethylene-2-methyl-6-(p-dimethylaminostyryl)-4H-pyrane, a rhodamine derivative such as rhodamine B, rhodamine 6G, rhodamine 101 and sulforhodamine 101, a pyridine derivative such as 1-ethyl-2-(4-(p-dimethylaminophenyl)-1,3-butadienyl)-pyridinium-perchlorate, a perylene derivative such as N,N′-bis(2,6-diisopropylphenyl)-1,6,7,12-tetraphenoxyperylene-3,4:9,10-bisdicarboimide, a porphyrin derivative, a pyrromethene derivative, an oxazine derivative, a pyrazine derivative, a compound having a fused aryl ring, such as naphthacene or dibenzodiindenoperylene, or a derivative thereof, or an organic metal complex compound. The component (A) may contain two or more of them as the luminescent material (b).

Among these compounds, a pyrromethene derivative gives a high fluorescence quantum yield, has good color purity durability, and is therefore a particularly suitable compound. Among the pyrromethene derivatives, a compound of the general formula (2) exhibits light emission with high color purity and is thus preferred.

As the organic luminescent material contained in the component (A), a compound that emits delayed fluorescence can also suitably be used. Compounds that emit delayed fluorescence are described on pages 87 to 103 of “State-of-the-Art Organic Light-Emitting Diodes” (edited by Adachi Chihaya and Fujimoto Hiroshi, published by CMC Publishing Co. Ltd.). The literature illustrates that by bringing the energy levels of the excited singlet and excited triplet states of a luminescent material into close proximity, the reverse energy transfers from the excited triplet state to the excited singlet state, which normally has a low transition probability, occurs with high efficiency, resulting in thermally activated delayed fluorescence (TADF). Further, the mechanism of generation of delayed fluorescence is illustrated in FIG. 5 in the literature. The delayed fluorescence emission can be determined by transient photo luminescence (PL) measurement.

In general, fluorescence is emitted from the singlet excited state generated after photoexcitation of the luminescent material, but the triplet excited state of the luminescent material generated by intersystem crossing is thermally deactivated under room temperature conditions. Therefore, no fluorescence is emitted from the triplet excited state of the luminescent material. On the other hand, as described above, compounds that emit delayed fluorescence, even when the triplet excited state is generated, are rapidly converted to the singlet excited state and then emit fluorescence. Therefore, the triplet excited state, which could not contribute to light emission in usual fluorescent materials, can contribute to fluorescence emission. Therefore, high-efficiency light emission is obtained. It can also be expected that compounds that emit delayed fluorescence are rapidly converted from the triplet excited state to the singlet excited state, and thus are unlikely to generate singlet oxygen, resulting in improved durability of the color conversion composition containing the compounds. The triplet excited state of luminescent materials and generation of singlet oxygen, as well as their relationship with durability are described in detail in a section <Component (C): Compound of General Formula (1)>.

For compounds that emit delayed fluorescence, it is required to bring the energy levels of the singlet excited and triplet excited states into close proximity. A molecular design is effective for achieving this, in which an electron-donating skeleton and an electron-accepting skeleton are combined in the same molecule, and thus the highest occupied molecular orbital (HOMO) and the lowest unoccupied molecular orbital (LUMO) are separated in the molecule. The electron-donating skeleton and the electron-accepting skeleton may be combined directly or via a linking group. In the latter case, the linking group is preferably a skeleton comprising aromatic hydrocarbon.

Examples of the electron-donating skeleton include skeletons having a nitrogen atom of amine. Especially, skeletons containing diarylamine or triarylamine, skeletons containing carbazole, skeletons containing benzocarbazole, skeletons containing indolocarbazole, skeletons containing phenoxazine, and skeletons containing phenothiazine are preferable. Among them, skeletons containing carbazole, skeletons containing benzocarbazole, skeletons containing indolocarbazole, and skeletons containing phenoxazine are more preferable, and skeletons containing carbazole and skeletons containing phenoxazine are still more preferable.

On the other hand, the electron-accepting skeleton may be, in general, a skeleton containing an electron-attracting substituent (i.e., electron withdrawing group). Among the skeletons containing an electron withdrawing group, for example, skeletons containing a heteroaryl group having a partial structure with carbon and nitrogen atoms bonded by a double bond to each other, skeletons containing a fluorinated substituent, skeletons containing a cyano group, skeletons containing a carbonyl group, skeletons containing sulfoxide or disulfoxide, and skeletons containing a phosphine oxide group are preferable. Among them, skeletons containing a heteroaryl group having a partial structure with carbon and nitrogen atoms bonded by a double bond to each other, skeletons containing a fluorinated substituent, and skeletons containing a cyano group are more preferable in view of stability of the compound.

Among the skeletons containing a heteroaryl group having a partial structure with carbon and nitrogen atoms bonded by a double bond to each other, specifically, skeletons containing pyridine, pyrimidine, pyrazine, triazine, quinoline, quinoxaline, quinazoline, or phenanthroline are preferable. Among them, skeletons containing pyrimidine, triazine, quinoxaline, or quinazoline are more preferable; and skeletons containing triazine are still more preferable.

Among the skeletons containing a fluorinated substituent, skeletons containing a fluorinated aryl group or a fluoroalkyl group are more preferable. As the skeletons containing a fluorinated aryl group, fluorinated benzene rings are preferable, and specifically, skeletons containing fluorobenzene, difluorobenzene, trifluorobenzene, tetrafluorobenzene, or pentafluorobenzene are more preferable. As the skeletons containing a fluoroalkyl group, skeletons containing a benzene ring substituted with a trifluoromethyl group are preferable, and especially skeletons containing mono(trifluoromethyl)benzene or bis(trifluoromethyl)benzene are more preferable.

Among skeletons having a cyano group, skeletons containing cyanobenzene, dicyanobenzene, or tricyanobenzene are more preferable.

Examples of the compounds in which an electron-donating skeleton and an electron-accepting skeleton are bonded as described above are shown below, but the compounds are not limited thereto. It is noted that the compounds shown here are known to emit delayed fluorescence according to past literature.

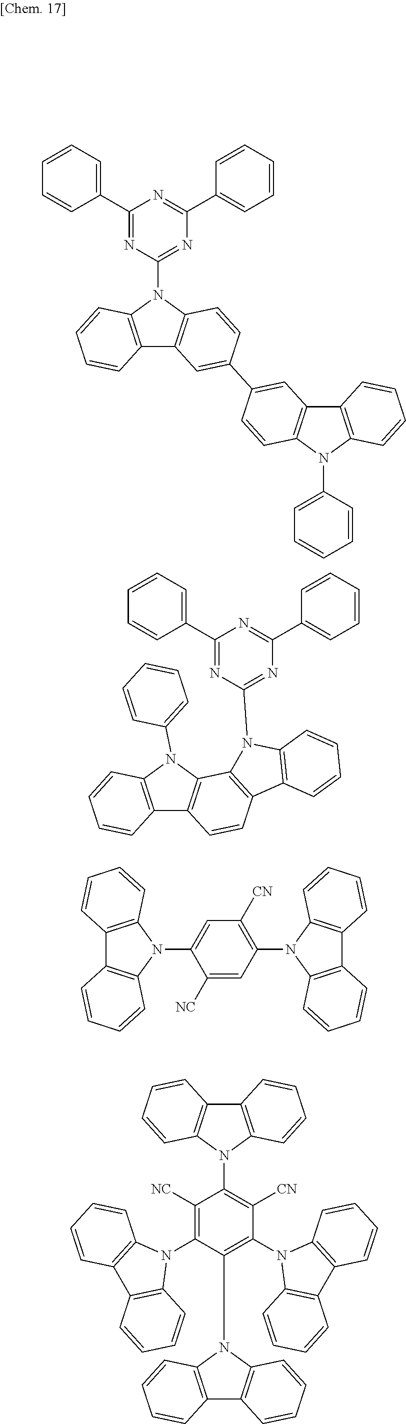

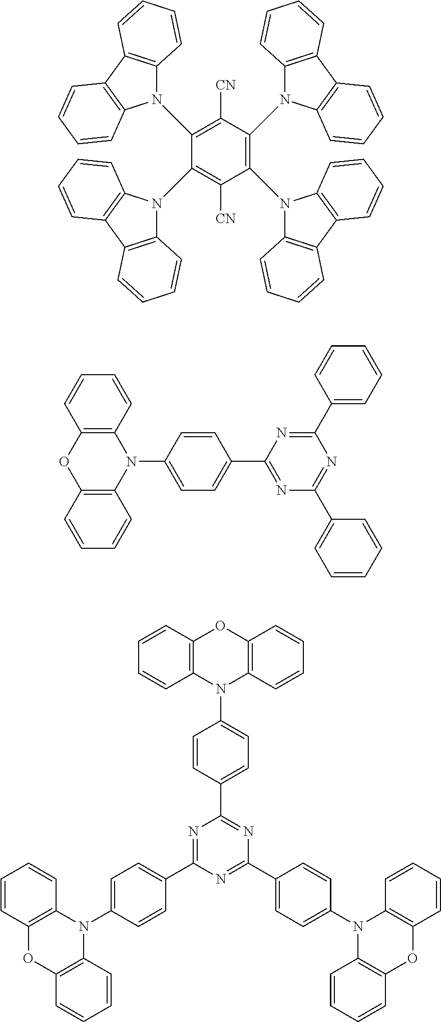 [SMILES: N#Cc1c(-n2c3ccccc3c3ccccc32)c(-n2c3ccccc3c3ccccc32)c(C#N)c(-n2c3ccccc3c3ccccc32)c1-n1c2ccccc2c2ccccc21 ; c1ccc(-c2nc(-c3ccccc3)nc(-c3ccc(N4c5ccccc5Oc5ccccc54)cc3)n2)cc1 ; c1ccc2c(c1)Oc1ccccc1N2c1ccc(-c2nc(-c3ccc(N4c5ccccc5Oc5ccccc54)cc3)nc(-c3ccc(N4c5ccccc5Oc5ccccc54)cc3)n2)cc1]

In addition to the compounds in which an electron-donating skeleton and an electron-accepting skeleton are bonded as described above, a compound of the general formula (11) below and a compound of the general formula (12) can also be used more suitably as a compound that emits delayed fluorescence:

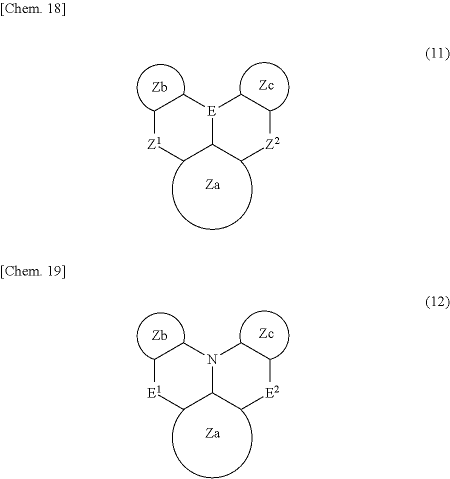

In the general formula (11) or (12), each of the ring Za, the ring Zb, and the ring Zc independently is a substituted or unsubstituted aryl ring having a ring-forming carbon number of 6 to 40, or a substituted or unsubstituted heteroaryl ring having a ring-forming carbon number of 6 to 40.

In the general formula (11), each of Z¹ and Z² independently is an oxygen atom, NRa (a nitrogen atom having a substituent R^{a}), or a sulfur atom. When Z¹ is NRa, the substituent Ra may or may not be bonded to the ring Za or the ring Zb to form a ring; and when Z² is NRa, the substituent Ra may or may not be bonded to the ring Za or the ring Zc to form a ring. E is a boron atom, a phosphorus atom, SiRa (a silicon atom having a substituent Ra), P═O, or P═S.

In the general formula (12), each of E¹ and E² independently is BRa (a boron atom having a substituent Ra), PRa (a phosphorus atom having a substituent R^{a}), SiRa₂ (a silicon atom having two substituents Ra), P(═O)Ra₂ (phosphine oxide having two substituents Ra), or P(═S)Ra₂ (phosphine sulfide having two substituents Ra), C═O (a carbonyl group), S(═O), or S(═O)₂. When E¹ is BRa, PRa, SiRa₂, P(═O)Ra₂, or P(═S)Ra₂, the substituent Ra may be bonded to the ring Za or the ring Zb to form a ring. When E² is BRa, PRa, SiRa₂, P(═O)Ra₂, or P(═S)Ra₂, the substituent Ra may be bonded to the ring Za or the ring Zc to form a ring.

Each of the above substituents Ra independently is selected from a hydrogen atom, an alkyl group, a cycloalkyl group, a heterocyclic group, an alkenyl group, a cycloalkenyl group, an alkynyl group, an aryl group, a heteroaryl group, a hydroxyl group, a thiol group, an alkoxy group, an alkylthio group, an aryl ether group, an aryl thioether group, halogen, a cyano group, an aldehyde group, a carbonyl group, a carboxyl group, an oxycarbonyl group, an ester group, a carbamoyl group, an amide group, a sulfonyl group, a sulfonic acid ester group, a sulfonamide group, an amino group, an imino group, a nitro group, a silyl group, a siloxanyl group, a boryl group, a phosphine oxide group, a perfluoroalkyl group, and a fused ring and an aliphatic ring each formed between adjacent substituents. Moreover, the substituent Ra may be further substituted with a substituent selected from them. The substituent with which the substituent Ra is substituted may be further substituted with a substituent selected from them.

In all of the groups above, when the group is substituted, the substituent is an alkyl group, a cycloalkyl group, a heterocyclic group, an alkenyl group, a cycloalkenyl group, an alkynyl group, an aryl group, a heteroaryl group, a hydroxyl group, a thiol group, an alkoxy group, an alkylthio group, an aryl ether group, an aryl thioether group, halogen, a cyano group, an aldehyde group, a carbonyl group, a carboxyl group, an oxycarbonyl group, a perfluoroalkyl group, an amide group, a sulfonyl group, a sulfonate group, a sulfonamide group, an amino group, an imino group, a nitro group, a silyl group, a siloxanyl group, a boryl group, or a phosphine oxide group. These substituents may further be substituted with the above-described substituent.

Examples of the substituted or unsubstituted aryl ring having a ring-forming carbon number of 6 to 40 in the rings Za, Zb, and Zc include aromatic hydrocarbon rings such as benzene rings, naphthalene rings, phenanthrene rings, chrysene rings, anthracene rings, and pyrene rings. Among them, benzene rings are preferable in view of ensuring the solubility. Examples of the heteroaryl ring having a ring-forming carbon number of 6 to 40 include aromatic heteroaryl ring structures such as pyridine rings, quinoline rings, and phenanthroline rings. Among them, pyridine rings are preferable, in view of raw-material availability and difficulty of synthesis.

Further, in the general formula (11) and the general formula (12), the substituent Ra is preferably a group having a carbon number of 6 to 40 including that of the substituent. The substituent Ra is more preferably a substituted or unsubstituted aryl group, a substituted or unsubstituted heteroaryl group, or a substituted or unsubstituted alkyl group. Examples of the substituted or unsubstituted aryl group include substituted or unsubstituted phenyl groups, substituted or unsubstituted biphenyl groups, substituted or unsubstituted fluorenyl groups, substituted or unsubstituted naphthyl groups, and substituted or phenanthrenyl groups. Among them, substituted or unsubstituted phenyl groups are more preferable.

In addition, due to the multiple resonance effect of the compound of the general formula (11) or the general formula (12), an emission spectrum shown by the compound is sharper than those shown by compounds in which an electron-donating skeleton and an electron-accepting skeleton are bonded. Therefore, since the compound that emits delayed fluorescence is a compound of the general formula (11) or the general formula (12), light emission with high color purity can be obtained. That is, the compounds of the general formula (11) or the general formula (12) are preferred as compounds that emit delayed fluorescence because they are advantageous for color gamut improvement of displays. Furthermore, the compound of the general formula (11) or the general formula (12) has the ring Za, ring Zb, and ring Zc present surrounding the E atom in the general formula (11) or the general formula (12), in which LUMO is mainly localized, and thus the E atom, or most LUMO, can be protected. Thus, the electronic interaction due to collision between the compound of the general formula (11) or the general formula (12) and the component (C) can be prevented. This enables holding the high fluorescence quantum yield originally possessed by the compound of the general formula (11) or the general formula (12) while allowing the component (C) to exert the effect of improving the durability. From this point of view, the compounds of the general formula (11) or the general formula (12) are preferred as compounds that emit delayed fluorescence. The above E atom is the E atom in the general formula (11), and is each of E¹ and E² atoms in the general formula (12).

Furthermore, in each of the general formula (11) and the general formula (12), the substituent Ra more preferably forms a structure in which the substituent Ra is bonded to at least one ring of the ring Za, ring Zb, and ring Zc. This is because bonding of the substituent Ra to at least one ring of the ring Za, ring Zb, and ring Zc can be expected to further enhance the effect of sterically protecting E in the general formula (11) and E¹ and E² in the general formula (12) and further improve the effect of preventing reduction of the fluorescence quantum yield.

Examples of the compound of the general formula (11) or the general formula (12) are illustrated below, but the present invention is not particularly limited thereto.

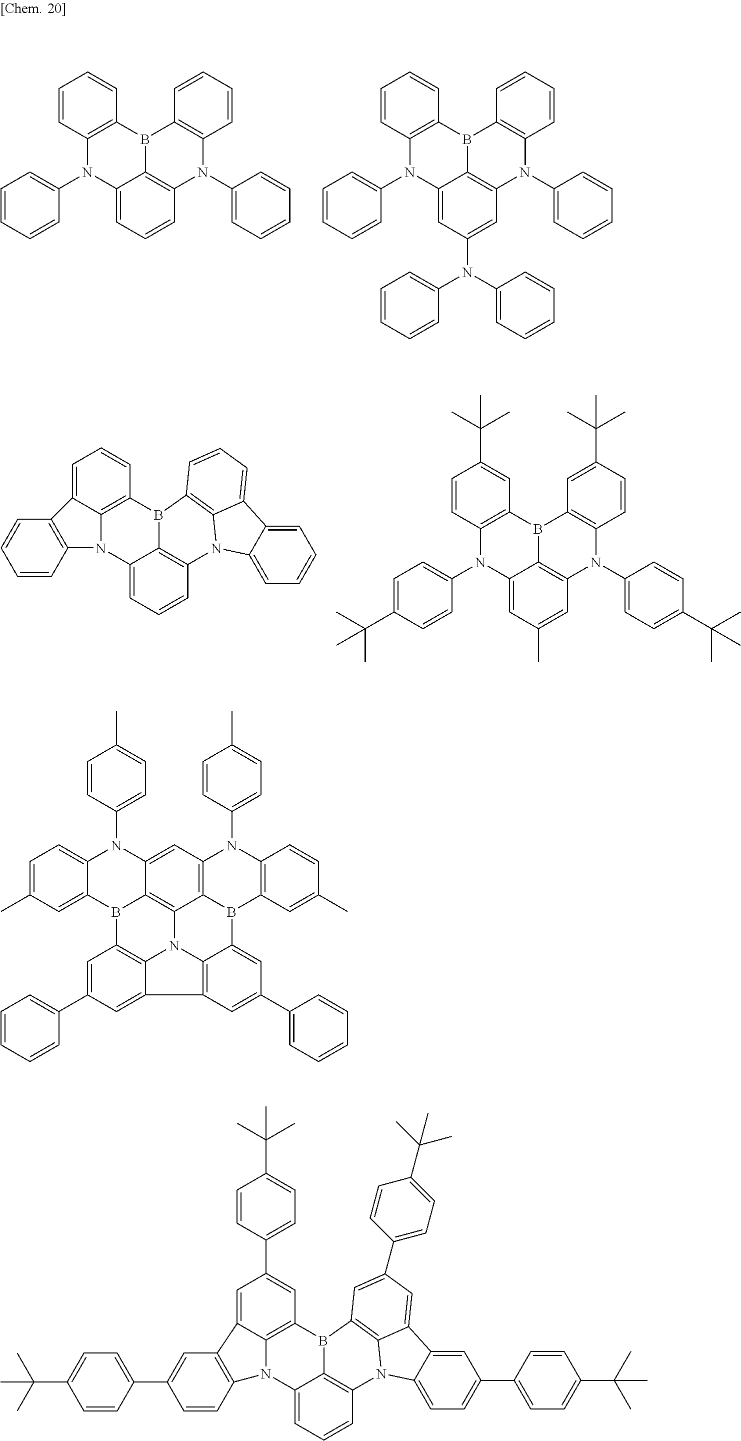

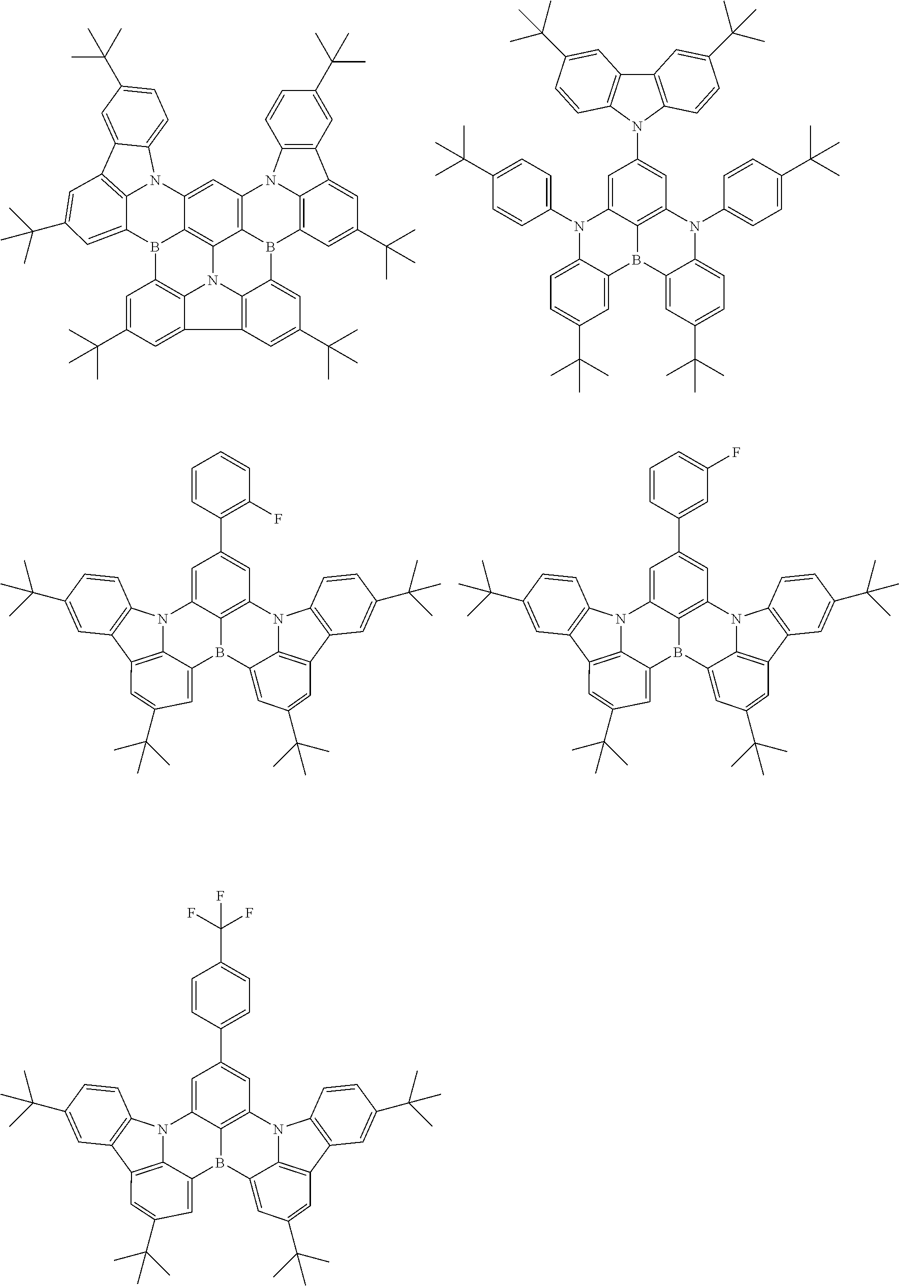

The amount of the component (A) in the color conversion composition according to the embodiment of the present invention can be selected depending on the molar extinction coefficient, fluorescence quantum yield, and absorption intensity at the excitation wavelength of the compound and the thickness and transmittance of the sheet formed. Here, the amount of the component (A) in the case where two or more components (A) are contained in the color conversion composition of the present invention means the total amount thereof. The amount of the component (A) is preferably from 1.0×10⁻² parts by weight to 5 parts by weight per 100 parts by weight of the component (B).

In the case where the color conversion composition of the present invention contains both a luminescent material (a) providing green emission and a luminescent material (b) providing red emission, since part of green emission is converted to red emission, the amount wₐ of the luminescent material (a) and the amount w_{b} of the luminescent material (b) preferably have a relationship of wₐ≥w_{b}, and the amount ratio wₐ:w_{b} of the luminescent material (a) and (b) is preferably from 200:1 to 3:1. Here, the amount wₐ and the amount w_{b} are in percent by weight relative to the weight of the component (B).

### <Component (B): Binder Resin>

The color conversion composition of the present invention contains a binder resin as the component (B). The binder resin may be a material which forms a continuous phase and has excellent moldability, transparency, heat resistance, etc. Examples of the binder resin include known resins, for example, a photocurable resist material having a reactive vinyl group, such as an acrylic, methacrylic, poly(vinyl cinnamate)-based, or cyclic rubber-based resin, an epoxy resin, a silicone resin (including a cured (crosslinked) organopolysiloxane such as silicone rubber or silicone gel), a urea resin, a fluororesin, a polycarbonate resin, an acrylic resin, a urethane resin, a melamine resin, a polyvinyl resin, a polyamide resin, a phenol resin, a polyvinyl alcohol resin, a cellulose resin, an aliphatic ester resin, an aromatic ester resin, an aliphatic polyolefin resin, and an aromatic polyolefin resin. Copolymers of these resins may also be used as the binder resins. By appropriately designing these resins, binder resins which are useful for the color conversion composition and color conversion sheet of the present invention can be obtained.

Among these resins, thermoplastic resins are more preferred because of ease of molding process such as sheet formation. Among thermoplastic resins, from the viewpoints of transparency, heat resistance, etc., epoxy resins, silicone resins, acrylic resins, ester resins, olefin resins, or mixtures thereof can be suitably used. From the viewpoint of durability, particularly preferred thermoplastic resins are acrylic resins, ester resins and cycloolefin resins.

Suitable specific examples of the binder resin include those described in WO 2016/190283, WO 2017/61337, WO 2018/43237, WO 2019/21813, and WO 2019/188019.

In addition, a dispersing agent, a leveling agent, etc. for stabilizing the applied film can be added as an additive to the binder resin, or an adhesion aid such as a silane coupling agent can be added as a sheet surface modifier to the binder resin. Inorganic particles such as silica particles or silicone fine particles can also be added to the binder resin as a color conversion material sedimentation inhibitor.

### <Component (C): Compound of General Formula (1)>

The color conversion composition according to the embodiment of the present invention contains a compound of the general formula (1) below as the component (C) in order to prevent deterioration of the luminescent material contained as the component (A) described above and to reduce the change over time in and improve the durability of chromaticity. The component (C) has a role of singlet oxygen quencher.

The singlet oxygen quencher is a compound that traps and deactivates singlet oxygen resulting from activation of an oxygen molecule in the ground state due to excitation energy. Presence of a singlet oxygen quencher in a color conversion composition makes it possible to prevent singlet oxygen from oxidizing and deteriorating the luminescent material in the color conversion composition. Hereinafter, the mechanisms of generation of singlet oxygen, and of deactivation of singlet oxygen by singlet oxygen quenchers are described in order.

First, the mechanisms of generation of singlet oxygen are described. Singlet oxygen is thought to be hardly generated by direct photoexcitation of triplet oxygen in the ground state. This is because the transition from triplet oxygen in the ground state to singlet oxygen in the excited state is spin-forbidden transition, and thus the transition probability is very low. Thus, generation of singlet oxygen in the color conversion composition of the present invention is considered to be caused by dye sensitization.

In other words, singlet oxygen is considered to result from exchange of electron and energy between the luminescent material in the triplet excited state and a triplet oxygen molecule in the ground state. The mechanism of generation is considered to be as follows. First, photoexcitation makes a luminescent material in the singlet ground state into the luminescent material in the singlet excited state, and intersystem crossing makes a part of the luminescent material in the singlet excited state into the luminescent material in the triplet excited state. Since the transition from the generated luminescent material in the triplet excited state to the luminescent material in the singlet ground state is spin-forbidden transition, the transition probability is generally low. However, when triplet oxygen in the ground state coexists, excitation from triplet oxygen in the ground state to singlet oxygen in the excited state is accompanied, which lifts the spin-forbidden transition, so that the luminescent material in the triplet excited state can be rapidly deactivated into the luminescent material in the singlet ground state.

This mechanism is called Dexter mechanism (electron exchange mechanism). For proceeding of the Dexter mechanism, electron exchange via superposition of wave function between molecules is required, and thus direct collision between an energy-donating molecule (in this case, luminescent material in the triplet excited state) and an energy-accepting molecule (in this case, triplet oxygen in the ground state) seems to be required.

Next, the mechanisms of deactivation of singlet oxygen by singlet oxygen quenchers is described. The transition from singlet oxygen in the excited state to triplet oxygen in the ground state is spin-forbidden transition, and thus the transition probability is generally low. When a singlet oxygen quencher coexists, similarly to the mechanism of generation of singlet oxygen described above, excitation from a singlet oxygen quencher in the ground state to a triplet oxygen quencher in the excited state is accompanied, which lifts the spin-forbidden transition, so that singlet oxygen can be rapidly deactivated into triplet oxygen in the ground state.

In order for a certain compound to act as a singlet oxygen quencher, the compound is preferably excited with a smaller energy than the excitation energy of singlet oxygen. In the present invention, the component (C) in the color conversion composition, that is, the compound of the general formula (1) acts as a singlet oxygen quencher and improves the durability of the luminescent material that is the component (A) in the color conversion composition. Specific examples of the compound of the general formula (1) are illustrated below.

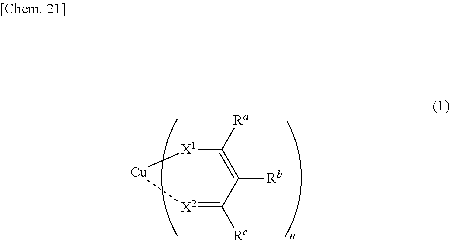

A compound of the general formula (1) is an organic acid salt of copper, as described above. The organic acid salt of copper can efficiently absorb the excitation energy of singlet oxygen. Therefore, the compound of the general formula (1) is considered to act effectively as a singlet oxygen quencher. On the other hand, even when a metal other than copper, for example, nickel is used as a singlet oxygen quencher, the excitation energy of singlet oxygen cannot be efficiently absorbed and therefore the durability of the luminescent material is insufficient.

In general, metal complexes are known to undergo ligand exchange, and the rate of this ligand exchange is determined by several factors, such as the size of the activation energy barrier between metal complexes, the ligand-field stabilization energy (LFSE), and electrostatic effects. Therefore, when considering the stability of a metal complex, it is necessary to take these multiple factors into consideration. The classification of hard acid, hard base; soft acid, soft base (HSAB) is an empirical distinction between acids and bases based on the stability of their complexes. Since hard acids tend to bind with hard bases and soft acids tend to bind with soft bases, these binding tendencies are particularly useful in predicting the stability of metal complexes. Hard acids which are less likely to be easily polarized form complexes mainly based on ionic interactions, with hard bases which are highly electron-donating, while soft acids which are highly polarizable form complexes in which covalent bonds are more important, with soft bases.

As a copper (Cu) ion, stable Cu²⁺ is classified as an intermediate acid, while Cu¹⁺ is classified as a soft acid. In general, to obtain a highly stable Cu complex, the coordinating atom to the central metal is preferably N, S, Por C. However, the color of Cu complex in which the coordinating atom is N or P often shows black to dark blue. Therefore, when Cu complexes are used as singlet oxygen quenchers, said Cu complexes absorb excitation light and color-converted light. This leads to a decrease in fluorescence quantum yield. Therefore, there is a need for singlet oxygen quenchers that are stable Cu complexes coordinated by O or S atoms.

In the compound of the above general formula (1), X¹ and X² are each independently O or S. Each of R^{a} to R^{c} is independently selected from a hydrogen atom, an alkyl group, a cycloalkyl group, a heterocyclic group, an alkenyl group, a cycloalkenyl group, an alkynyl group, a hydroxyl group, an alkoxy group, a thiol group, an alkylthio group, an aryl ether group, an aryl thioether group, an aryl group, a heteroaryl group, halogen, a cyano group, an aldehyde group, an oxycarbonyl group, a carbamoyl group, an amino group, a nitro group, a silyl group, a siloxanyl group, a boryl group, a phosphine oxide group, and a fused ring or an aliphatic ring each formed between —C(═O)R¹⁰¹, —S(═O)R¹⁰²R¹⁰³, —S(═O)R¹⁰⁴, —S(═O)₂R¹⁰⁵, and adjacent substituents. R¹⁰¹ to R¹⁰⁵ are substituents, and R¹⁰² and R¹⁰³ may be fused with each other to form a ring, provided that at least one of R^{a} to R^{c} is an electron withdrawing group. n is an integer of 1 to 4.

In the compound of the general formula (1), each substituent has the same meaning as explained in the above section <Component (A): Luminescent Material>. Further explanation is provided below.

When at least one of R^{a} to R^{c} in the general formula (1) is an electron withdrawing group, the electron-donating property of a coordinating atom close to the electron withdrawing group can be reduced. As a result, the bond between Cu and the ligand in the general formula (1) can be stabilized. In this case, the remaining groups among R^{a} to R^{c}, excluding the electron withdrawing groups, are not particularly limited. It is because they can ensure enough stability to obtain good humidity resistance even when they are electron-donating groups such as butyl groups.

For example, acetylacetone, which is a polydentate ligand containing an O atom, is a typical hard base and inherently has a relatively weak bond with Cu. For this reason, in a high temperature and high humidity environment, the ligands are released by excess moisture, and the copper decomposes to produce black Cu. To prevent this, in the compound of the general formula (1), the bond between Cu and the ligand can be stabilized by controlling the electron-donating property to Cu by the electron withdrawing group which is at least one of R^{a} to R^{c} in the ligand. Therefore, the reaction between the ligand and water in a high humidity environment is suppressed, and a singlet oxygen quencher with high humidity resistance can be obtained.

Further, Cu may have a valence of 1 to 4. That is, in the compound of the general formula (1), n is an integer of 1 to 4, preferably an integer of 1 to 3, and more preferably an integer of 1 to 2. This is because Cu²⁺ is classified as an intermediate acid, and Cu¹⁺ is classified as a soft acid. In addition, in the general formula (1), R¹⁰¹ to R¹⁰⁵ are not particularly limited, but may be an electron-donating group such as a butyl group or an electron withdrawing group such as a perfluoroalkyl group, and it is preferable that these groups improve the solubility of the singlet oxygen quencher.

The electron withdrawing group in the compound of the general formula (1) is preferably selected from the group of electron withdrawing groups shown in the above section <Component (A): Luminescent Material>, and among them, a group containing a fluorine atom that has little interaction with Cu is more preferred, and a group having a fluorine number of 4 or more is even more preferred. Further, the group having a fluorine number of 4 or more is particularly preferably a perfluoroalkyl group. To improve the solubility of singlet oxygen quenchers, the perfluoroalkyl group as the electron withdrawing group is preferably a group having a carbon number of two or more.

From the viewpoint that singlet oxygen and singlet oxygen quencher are more accessible to each other, it is preferable that at least one of R^{a} to R^{c} in the general formula (1) is a hydrogen atom, and in particular, it is more preferable that Rb is a hydrogen atom.

Furthermore, in the general formula (1), X¹ and X², which are atoms coordinated to Cu, are preferably atoms having unpaired electrons to strengthen the bond with Cu. Therefore, X¹ and X² are independently O or S. In particular, both X¹ and X² are preferably O, due to the advantage of the lighter color of the singlet oxygen quencher itself.

In the compound of the general formula (1), at least one of R^{a} to R^{c} is preferably an electron withdrawing group as mentioned above. The electron withdrawing group is preferably a group containing a fluorine atom, more preferably a group having a fluorine number of 4 or more, and even more preferably a perfluoroalkyl group having a carbon number of 2 or more. Furthermore, among R^{a} to R^{c}, it is particularly preferred that Rb is a hydrogen atom and X¹ and X² are both O.

Specific examples of the compound of the general formula (1) are as shown below.

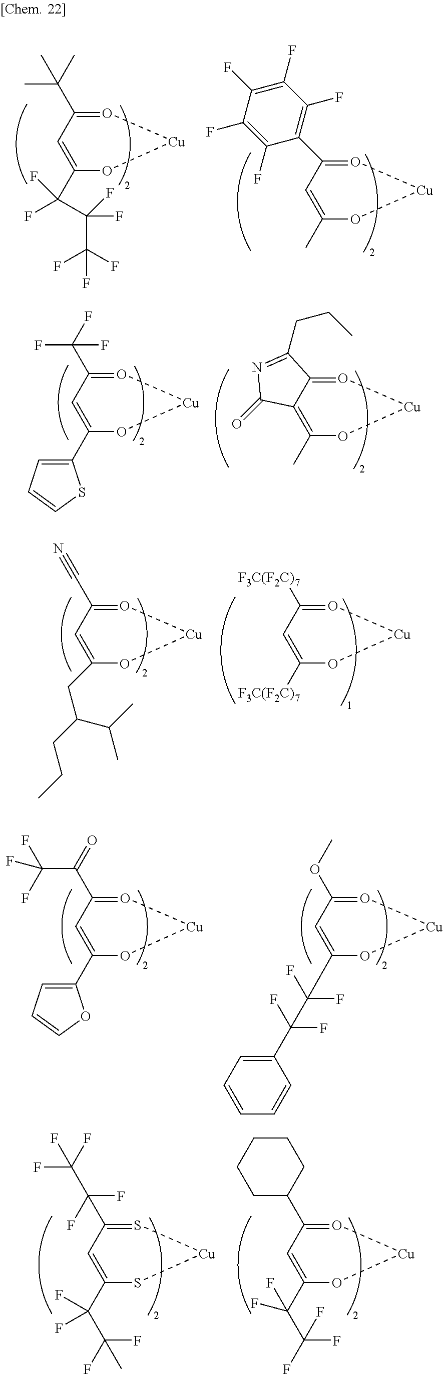

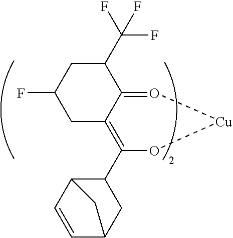

### <Other Additives>

The color conversion composition according to the embodiment of the present invention may contain, in addition to the above-mentioned components (A), (B) and (C), a filler, an antioxidant, a processing and heat stabilizer, a light resistance stabilizer such as an UV absorber, a dispersant or a leveling agent for stabilizing the applied film, a scattering agent, a plasticizer, a crosslinking agent such as an epoxy compound, a curing agent such as amine, acid anhydride, and imidazole, a pigment, an adhesion aid such as a silane coupling agent as a film surface modifier, and other additives.

Examples of the fillers include microparticles such as fumed silica, glass powder, and quartz powder, and titanium oxide, zirconium oxide, barium titanate, zinc oxide, and silicone microparticles. The color conversion composition of the present invention may contain one or two or more of them as the filler.

Examples of the antioxidants include phenol antioxidants such as 2,6-di-tert-butyl-p-cresol and 2,6-di-tert-butyl-4-ethylphenol. The color conversion composition of the present invention may contain one or two or more of them as the antioxidant.

Examples of the processing and heat stabilizer include phosphorus-based stabilizers such as tributyl phosphite, tricyclohexyl phosphite, triethylphosphine, and diphenylbutylphosphine. The color conversion composition of the present invention may contain one or two or more of them as the processing and heat stabilizer.

Examples of the light resistance stabilizer include benzotriazoles such as 2-(5-methyl-2-hydroxyphenyl)benzotriazole, and 2-[2-hydroxy-3,5-bis(α,α-dimethylbenzyl)phenyl]-2H-benzotriazole. The color conversion composition of the present invention may contain one or two or more of them as the light resistance stabilizer.

The amount of the additives in the color conversion composition according to the embodiment of the present invention can also be set depending on the molar extinction coefficient, fluorescence quantum yield, and absorption intensity at the excitation wavelength of the compound, and the thickness and transmittance of the sheet formed. The amount of the additives is preferably from 1.0×10⁻¹ parts by weight to 10 parts by weight per 100 parts by weight of the component (B).

### <Solvent>

The color conversion composition according to the embodiment of the present invention may further contain a solvent in addition to the component (A), component (B), and component (C) above. Preferably, the solvent can adjust the viscosity of a resin in a flowing state, and does not excessively affect the emission from a luminescent substance and the durability. Examples of the solvent include water, 2-propanol, ethanol, toluene, methyl ethyl ketone, methyl isobutyl ketone, cyclohexanone, hexane, acetone, ethyl acetate, butyl acetate, terpineol, Texanol, Methyl Cellosolve, Ethyl Cellosolve, butyl carbitol, butyl carbitol acetate, 1-methoxy-2-propanol, and propylene glycol monomethyl ether acetate. The color conversion composition of the present invention may contain at least one or two or more of them as the solvent. Especially among these solvents, ethyl acetate does not affect deterioration of the compound of the general formula (2), leaves less residual solvent after drying and therefore, is suitably used.

### <Method of Producing Color Conversion Composition>

One example of the method of producing the color conversion composition according to the embodiment of the present invention is described below. In this production method, the above-described components (A) to (C), and as necessary additives, solvents, and the like can be mixed so that a predetermined composition is achieved, and then homogeneously mixed or kneaded using a stirrer/kneader to obtain a color conversion composition. Examples of the stirrer/kneader include homogenizers, rotation-revolution stirrers, three-roll mills, ball mills, planetary ball mills, and beads mills. After mixing or dispersing, or in the process of mixing or dispersing, defoaming is also preferably performed under a vacuum or reduced-pressure condition. In addition, certain components may be mixed in advance, or treatment such as aging may be performed. It is also possible to remove the solvent using an evaporator to achieve the desired solid concentration.

### <Color Conversion Sheet>

The color conversion sheet according to the embodiment of the present invention (hereinafter sometimes abbreviated as color conversion sheet of the present invention) preferably includes a layer which is a color conversion layer composed of the above-mentioned color conversion composition or a cured product thereof. The cured product of the color conversion composition is preferably included in the color conversion sheet as a layer obtained by curing the color conversion composition (a layer composed of the cured product of the color conversion composition). Representative structural examples of the color conversion sheet of the present invention include the following four examples.

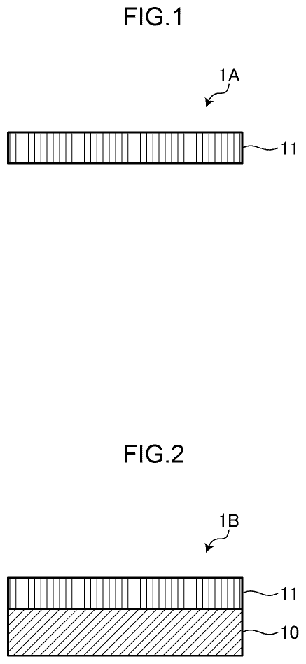

FIG. 1 is a schematic cross-sectional view illustrating the first example of the color conversion sheet according to the embodiment of the present invention. As shown in FIG. 1, the color conversion sheet 1A of this first example is a single-layer sheet composed of a color conversion layer 11. The color conversion layer 11 is a layer composed of the color conversion composition of the present invention or a cured product thereof.

FIG. 2 is a schematic cross-sectional view illustrating the second example of the color conversion sheet according to the embodiment of the present invention. As shown in FIG. 2, the color conversion sheet 1B of this second example is a laminate of a substrate layer 10 and a color conversion layer 11. In the structural example of the color conversion sheet 1B, the color conversion layer 11 is laminated on the substrate layer 10.

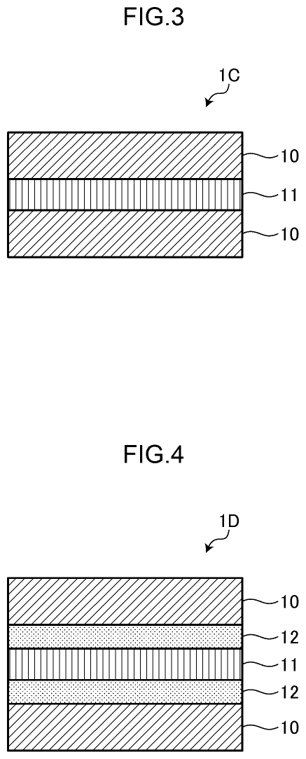

FIG. 3 is a schematic cross-sectional view illustrating the third example of the color conversion sheet according to the embodiment of the present invention. As shown in FIG. 3, the color conversion sheet 1C of this third example is a laminate of the substrate layer 10 and the color conversion layer 11. In the structural example of this color conversion sheet 1C, the color conversion layer 11 is sandwiched between a plurality of substrate layers 10.

FIG. 4 is a schematic cross-sectional view illustrating the fourth example of the color conversion sheet according to the embodiment of the present invention. As shown in FIG. 4, the color conversion sheet 1D of this fourth example is a laminate of a plurality of substrate layers 10, a color conversion layer 11, and a plurality of barrier films 12. In the structural example of this color conversion sheet 1D, the color conversion layer 11 is sandwiched between a plurality of barrier films 12, and furthermore, the laminate of the color conversion layer 11 and the plurality of barrier films 12 is sandwiched between the plurality of substrate layers 10. That is, the color conversion sheet 1D may have a barrier film 12 as shown in FIG. 4 to prevent deterioration of the color conversion layer 11 due to oxygen, water, or heat.

The thickness of the color conversion sheet according to the embodiment of the present invention is preferably 30 μm to 300 μm. As used herein, the thickness of the color conversion sheet refers to the total thickness of all layers contained in the color conversion sheet, and refers to the film thickness (mean film thickness) measured based on JIS K7130 (1999), Plastics-Film and sheeting-Determination of thickness, Measurement Method A, a method of measuring the thickness by mechanical scanning. When the thickness of the color conversion sheet of the present invention is 30 μm or more, the toughness of the sheet can be improved. When the thickness of the color conversion sheet of the present invention is 300 μm or less, cracking of the color conversion sheet can be prevented.

### (Substrate Layer)

Examples of the substrate layer (for example, the substrate layer 10 shown in FIG. 2 to FIG. 4) in the color conversion sheet of the present invention include glass and a resin film. The resin film is preferably a plastic film such as polyethylene terephthalate (PET), polyphenylene sulfide, polycarbonate, polypropylene, or polyimide. For the reason that separation of the film is facilitated, the surface of the substrate layer may be previously subjected to a release treatment. The thickness of the substrate layer is not particularly limited, but the lower limit is preferably 25 μm or more, and more preferably 38 μm or more. The upper limit is preferably 5,000 μm or less, and more preferably 3,000 μm or less.

### (Barrier Film)

The barrier film (for example, the barrier film 12 shown in FIG. 4) in the color conversion sheet of the present invention is used appropriately, for example, for improvement of the gas barrier properties of the color conversion layer. The barrier film (also referred to as barrier layer) preferably prevents entry of oxygen, water, heat, and the like into the color conversion layer. The color conversion sheet of the present invention may have two or more barrier films. For example, the color conversion sheet of the present invention may have barrier films on the both sides of the color conversion layer, like barrier films 12 illustrated in FIG. 4, or may have a barrier film on only one side of the color conversion layer.

The barrier film having gas barrier properties may be, for example, a film composed of an inorganic oxide such as silicon oxide, aluminum oxide, titanium oxide, tantalum oxide, zinc oxide, tin oxide, indium oxide, yttrium oxide, or magnesium oxide; an inorganic nitride such as silicon nitride, aluminum nitride, titanium nitride, or silicon carbide nitride; a metallic oxide thin film or a metal nitride thin film with another element added thereto; or a film composed of a resin such as polyvinylidene chloride, an acrylic resin, a silicone resin, a melamine resin, a urethane resin, a fluorine resin, or a polyvinyl alcohol resin, e.g., saponified vinyl acetate. The barrier film may contain two or more of them. In addition, the barrier film having a barrier function against water may be, for example, a film composed of a resin such as polyethylene, polypropylene, nylon, polyvinylidene chloride, a vinylidene chloride-vinyl chloride copolymer, a vinylidene chloride-acrylonitrile copolymer, a fluorine resin, or a polyvinyl alcohol resin, or saponified vinyl acetate.

According to the function required, the color conversion sheet of the present invention may further have a light diffusion layer, an adhesive layer, and an auxiliary layer having an antireflection function, an antiglare function, an antireflection-antiglare function, a hardcoat function (anti-friction function), an antistatic function, an antifouling function, an electromagnetic wave shielding function, an infrared cutting function, an ultraviolet cutting function, a polarizing function, or a toning function.

### (Other Films)

The color conversion sheet according to the embodiment of the present invention may further include a polarizing reflective film, a diffusion sheet, a prism sheet, a wavelength selective reflective film, etc. Suitable specific examples of the wavelength selective reflective film include those described in WO 2017/164155 and JP 2018-81250 A.

### <Method of Producing Color Conversion Sheet>

Next, one example of the method of producing the color conversion sheet according to the embodiment of the present invention is described below. In the method of producing the color conversion sheet, the color conversion composition prepared by the method described above is applied to the base material such as a substrate layer or a barrier layer, and allowed to dry, thereby to form a color conversion layer. When the binder resin contained in the color conversion composition is a thermosetting resin, the color conversion composition may be applied to a base material such as a substrate layer, and then thermally cured to form a color conversion layer. When the binder resin contained in the color conversion composition is a photocurable resin, the color conversion composition may be applied to a base material such as a substrate layer, and then photo-cured to form a color conversion layer.

The color conversion compositions can be applied by means of a reverse roll coater, a blade coater, a comma coater, a slit die coater, a direct gravure coater, an offset gravure coater, a kiss coater, a natural roll coater, an air knife coater, a roll blade coater, a two-stream coaters, a rod coater, a wire bar coater, an applicator, a dip coater, a curtain coater, a spin coater, a knife coater, or the like. In order to achieve film thickness uniformity of the color conversion layer, the composition is preferably applied by means of a slit die coater, a comma coater, or a dip coater.

The color conversion layer can be dried using a general heating apparatus such as hot air drier or infrared drier. In this case, the heating temperature is preferably from 60 to 200 °C, and the heating time period is preferably from 2 minutes to 4 hours. It is also possible to perform stepwise thermal curing of the color conversion layer by step-cure or other methods.

When the color conversion layer is formed by thermal curing, the heating apparatus may be, for example, a hot air oven. The heating conditions for thermal curing of the color conversion layer can be selected depending on the binder resin. For example, the heating temperature is preferably from 100 °C to 300 °C, and the heating time period is preferably from 1 minute to 2 hours.

When the color conversion layer is formed by photo-curing, the color conversion layer is preferably irradiated with high-energy light such as ultraviolet rays. The photoirradiation conditions for photo-curing of the color conversion layer can be selected depending on the binder resin. For example, the wavelength of the irradiated light is preferably from 200 nm to 500 nm, and the amount of irradiation is preferably from 10 mJ/cm² to 10 J/cm².

After preparing the color conversion layer, the substrate layer may be changed, as necessary. In this case, simple methods include, for example, methods of re-laminating the substrate by using a hot plate, and methods using a vacuum laminator or a dry film laminator.

### <Light Source Unit>

The light source unit according to the embodiment of the present invention (hereinafter sometimes abbreviated as light source unit of the present invention) preferably includes at least a light source and the above-mentioned color conversion composition or color conversion sheet. The light source included in the light source unit of the present invention serves as a source of the above-mentioned excitation light. The methods of positioning the light source and the color conversion sheet are not particularly limited, and a constitution in which the light source may be in close contact with the color conversion film, or a remote phosphor system in which the light source is separated from the color conversion film may be employed. In addition, for the purpose of increasing the color purity, the light source unit of the present invention may employ constitution further including a color filter.

### (Light Source)

As for the type of the light source included in the light source unit of the present invention, any light source may be used as long as it emits light in the wavelength region where the compound that emits delayed fluorescence (organic luminescent material) can absorb light. For example, any excitation light source, including a fluorescent light source such as a hot cathode fluorescent lamp, a cold cathode fluorescent lamp, or an inorganic electroluminescence (EL), an organic EL element light source, an LED light source, an incandescent light source, or sunlight can be utilized in principle. Among them, an LED light source is a suitable light source. For example, a light-emitting diode having a maximum light emission in the wavelength range of 400 nm to 500 nm is a more suitable LED light source. In display device or lighting applications, a light-emitting diode having a maximum light emission in the wavelength range of 400 nm to 500 nm is a more suitable LED light source from the viewpoint that the color purity of blue light is enhanced.

The above-described light source may have one emission peak or two or more emission peaks, and is preferably have one emission peak in order to increase the color purity. It is also possible to use a plurality of light sources having different types of emission peaks in an arbitrary combination.

The light source unit of the present invention is useful for various light sources such as spatial lighting, backlighting, and the like. Specifically, the light source unit of the present invention can be used for display devices, illumination apparatuses, interior, indicator and signboard applications, and is particularly suitably used for display devices and illumination apparatuses, in particular.

### <Display Device, Illumination Apparatus>

The display device according to the embodiment of the present invention includes at least the above-described light source unit. For example, in a display device such as a liquid crystal display, a light source unit having the above-mentioned light source and color conversion sheet, etc. is used as a backlighting unit. The illumination apparatus according to the embodiment of the present invention includes at least the above-described light source unit. For example, this illumination apparatus is configured to emit white light by combining a blue LED light source as a light source unit with a color conversion sheet that converts the blue light from this blue LED light source into light having a longer wavelength.

### EXAMPLES

The present invention is described below by referring to Examples, but the present invention is not limited by Examples below. First, evaluation methods in Examples and Comparative Examples will be described.

### <Evaluation of Durability Against Light>

For evaluation of durability against light, a light emitting device with a color conversion sheet to be evaluated, and the blue LED element (Model Number SMBB450H-1100, manufactured by Ushio Epitex Inc., emission peak wavelength: 450 nm) mounted therein was used. The color conversion sheet to be evaluated was prepared in each of Examples and Comparative Examples, and placed in a light emitting device for each of the Examples and the Comparative Examples. The blue LED element was lighted by flowing a current of 30 mA to such a light emitting device, and measured for the light emission intensity at the peak wavelength of the initial color-converted emission by using a spectral radiance meter (CS-1000, manufactured by KONICA MINOLTA, INC.). The distance between the color conversion sheet and the blue LED element in the light emitting device was set to be 3 cm. Then, after continuous irradiation of light from the blue LED element under an environment at 50 °C, the time required for the peak intensity of light emitted from the color conversion sheet to decrease by a certain amount was observed to evaluate the durability against light of the color conversion sheet.

### <Evaluation of Humidity Resistance>

For evaluation of humidity resistance, the color conversion sheets prepared in each of Examples and Comparative Examples were cut into 8 mm×8 mm samples, and the prepared samples were then excited with an excitation light having a wavelength of 450 nm and analyzed for initial fluorescence quantum yields using an absolute fluorescence quantum yield meter Quantaurus-QY manufactured by HAMAMATSU PHOTONICS K.K. Subsequently, the color conversion sheets prepared in each of Examples and Comparative Examples were cut into 10 cm×10 cm samples, and the prepared samples were stored under an environment at 85 °C and 85% RH for 800 hours, and then analyzed for fluorescence quantum yields in the same manner as described above. The humidity resistance of the color conversion sheet was evaluated by calculating the difference (fluorescence quantum yield difference) between the initial fluorescence quantum yield and the fluorescence quantum yield after 800 hours of storage, which were thus obtained. In the results of the humidity resistance evaluation, a smaller fluorescence quantum yield difference indicates better humidity resistance.

Materials used in the following Examples and Comparative Examples are as shown below. Compounds G-1, G-2 and compound R-1 are examples of the component (A) (luminescent material). Compounds Q-1 to Q-6 are examples of the component (C) (compound of the general formula (1)). Compounds X-1 to X-3 are examples of the metal complex other than the component (C).

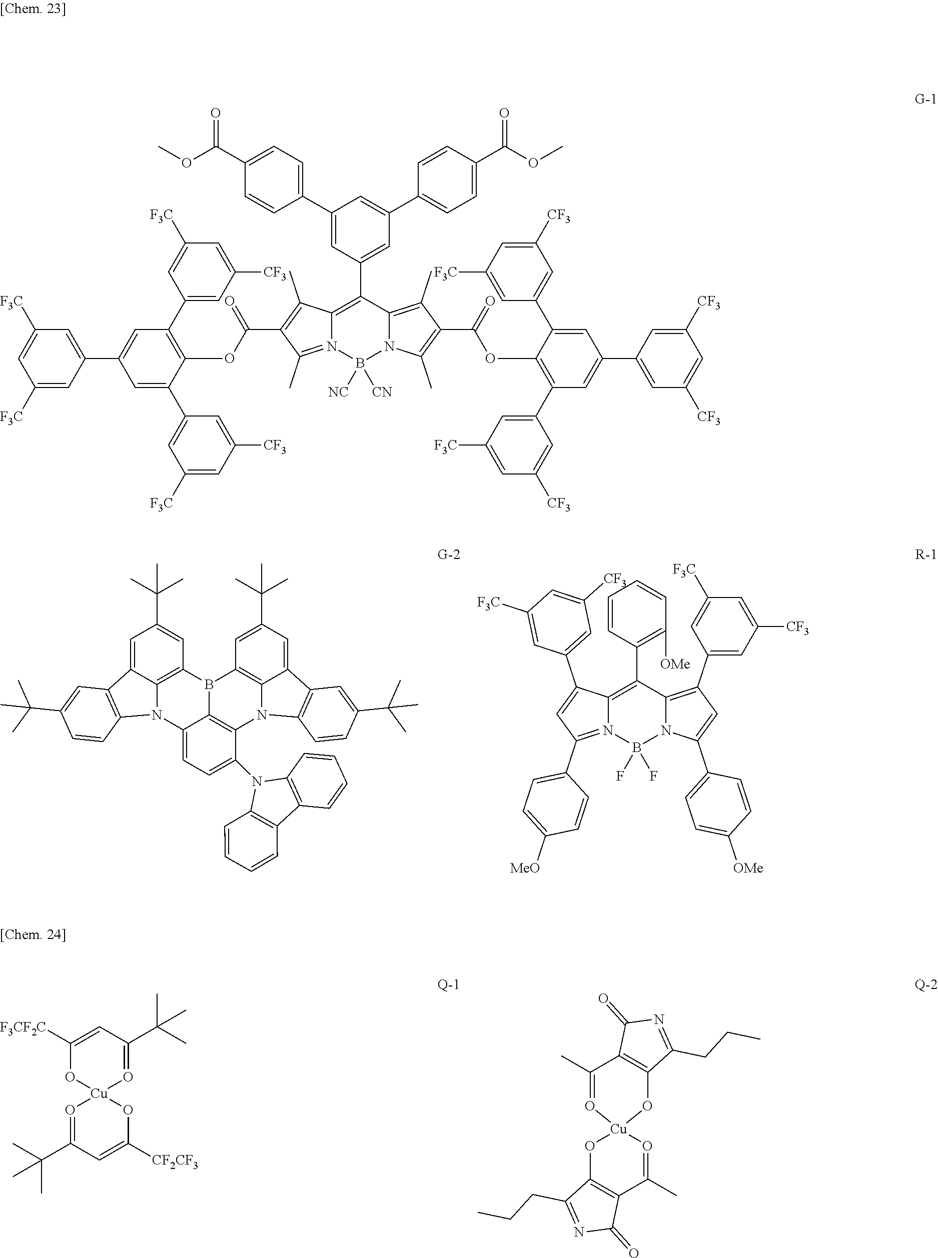

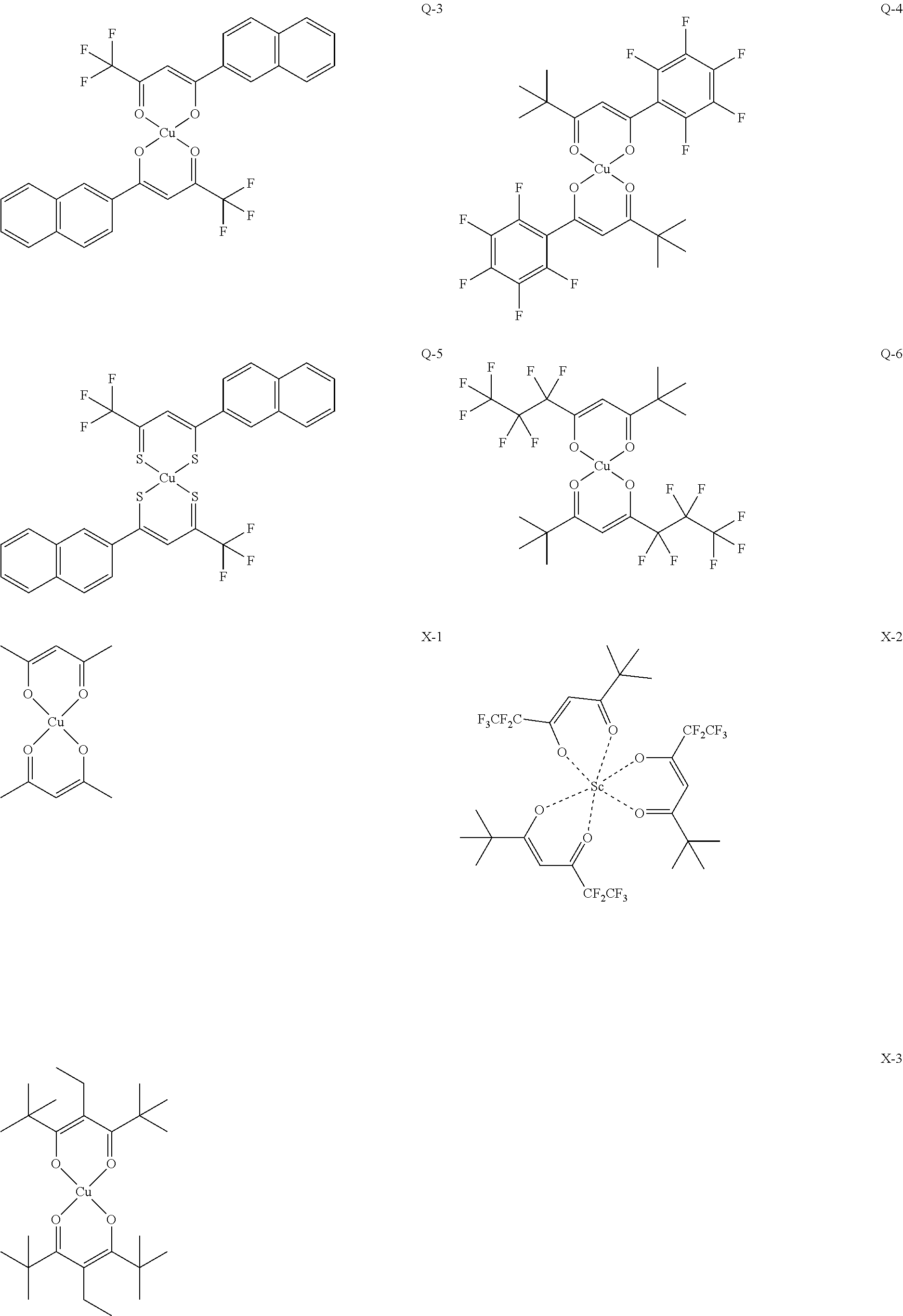

### Example 1

In Example 1, 0.40 parts by weight of compound G-1 as the component (A), 0.003 parts by weight (0.0287 equivalents relative to compound G-1) of compound Q-1 as the component (C), and 300 parts by weight of ethyl acetate as the solvent were added to 100 parts by weight of binder resin (BR-85) as the component (B). Then, the mixture was stirred and defoamed at 1,000 rpm for 20 minutes by using a planetary stirring/defoaming device, “MAZERUSTAR” (registered trademark) KK-400 (manufactured by Kurabo Industries Ltd.), to obtain a green color conversion composition as a resin liquid for preparation of a green color conversion layer.

Next, “Vylon” 630 was used as a binder resin which is the component (B), and 300 parts by weight of ethyl acetate as a solvent was mixed with 100 parts by weight of the component (B). Then, the mixture was stirred and defoamed at 300 rpm for 20 minutes by using a planetary stirring/defoaming device, “MAZERUSTAR” (registered trademark) KK-400 (manufactured by Kurabo Industries Ltd.), to obtain a resin composition for adhesive layer.

Next, the green color conversion composition was applied on a polyester film “Lumirror” (registered trademark) U48 (Toray Industries, Inc.; thickness: 50 μm) using a slit die coater, and heated and dried at 120 °C for 20 minutes thereby to form a green color conversion layer having a mean film thickness of 20 μm.

Similarly, the red color conversion composition was applied to a light diffusion film “CHEMICAL MAT” 125PW (Kimoto Co., Ltd.; thickness: 138 μm) on the side of the PET substrate layer side using a slit die coater, and heated and dried at 120 °C for 20 minutes, thereby to form a red color conversion layer having a mean film thickness of 20 μm.

Further, the resin composition for adhesive layer was applied to the above-described red color conversion layer formed on the PET substrate layer side of the light diffusion film “CHEMICAL MAT” 125 PW (manufactured by Kimoto Co., Ltd.; thickness: 138 μm) using a slit die coater, and heated and dried at 120 °C for 20 minutes, thereby to form an adhesive layer having a mean film thickness of 10 μm on the red color conversion layer.

Thereafter, the green color conversion layer and the red color conversion layer were bonded together via the adhesive layer, thereby preparing a color conversion sheet. Color conversion of blue light was performed using the thus prepared color conversion sheet. As a result, when only the green light emission region was extracted, green light emission showing a peak wavelength of 529 nm and providing an emission spectrum with a full width at half maximum at the peak wavelength of 27 nm was obtained. Evaluation of the durability against light and evaluation of humidity resistance of the color conversion sheet were performed in the same manner as described above. The components and evaluation results for Example 1 are as shown in Table 1 below.

### Examples 2 to 10, Comparative Examples 1 to 6

In Examples 2 to 8, the color conversion sheet was prepared in the same manner as in Example 1, except that the types of the components (A) and (C) used were as shown in Table 1, and the amount of the component (C) added was changed to be 0.0287 equivalent relative to the component (A). In Comparative Examples 1 to 3, compounds X-1 to X-3, which are other metal complexes, were added in place of the component (C), respectively. In Comparative Examples 4 to 6, the component (C) was not added. In each of Examples 2 to 10 and Comparative Examples 1 to 6, evaluation of the durability against light and evaluation of humidity resistance of the prepared color conversion sheets were performed. The components and evaluation results for each of Examples 2 to 10 and Comparative Examples 1 to 6 are as shown in Table 1.

TABLE 1

| | | | Metal complex | Durability | Fluorescence | Fluorescence | Fluorescence |
|---|---|---|---|---|---|---|---|
| | Component | Component | other than | against light | quantum yield | quantum yield | quantum yield |
| | (A) | (C) | component (C) | (hour) | (initial) | (800 hours) | difference |
| Example 1 | G-1 | Q-1 | Absent | 540 | 0.975 | 0.966 | 0.009 |
| Example 2 | G-1 | Q-2 | Absent | 410 | 0.957 | 0.938 | 0.019 |
| Example 3 | G-1 | Q-3 | Absent | 470 | 0.932 | 0.921 | 0.011 |
| Example 4 | G-1 | Q-4 | Absent | 510 | 0.941 | 0.924 | 0.017 |
| Example 5 | G-1 | Q-5 | Absent | 480 | 0.861 | 0.854 | 0.007 |
| Example 6 | G-1 | Q-6 | Absent | 560 | 0.978 | 0.970 | 0.008 |
| Example 7 | G-2 | Q-1 | Absent | 530 | 0.953 | 0.941 | 0.012 |
| Example 8 | G-2 | Q-6 | Absent | 535 | 0.955 | 0.944 | 0.011 |
| Example 9 | R-1 | Q-1 | Absent | 560 | 0.943 | 0.933 | 0.010 |
| Example 10 | R-1 | Q-6 | Absent | 565 | 0.944 | 0.935 | 0.009 |
| Comparative | G-1 | Absent | X-1 | 490 | 0.959 | 0.856 | 0.103 |
| Example 1 | | | | | | | |
| Comparative | G-1 | Absent | X-2 | 460 | 0.969 | 0.885 | 0.084 |
| Example 2 | | | | | | | |
| Comparative | G-1 | Absent | X-3 | 420 | 0.945 | 0.854 | 0.091 |
| Example 3 | | | | | | | |
| Comparative | G-1 | Absent | Absent | 300 | 1.001 | 0.994 | 0.007 |
| Example 4 | | | | | | | |
| Comparative | G-2 | Absent | Absent | 280 | 0.998 | 0.992 | 0.006 |
| Example 5 | | | | | | | |
| Comparative | R-1 | Absent | Absent | 370 | 0.944 | 0.938 | 0.006 |
| Example 6 | | | | | | | |

As is obvious from a comparison of Examples 1 to 10 with Comparative Examples 4 to 6, durability against light in each of Examples 1 to 10 was improved, compared to Comparative Examples 4 to 6 in which neither component (C) nor another metal complex was added.

As is obvious from a comparison of Examples 1 to 10 with Comparative Examples 1 to 3, humidity resistance in Examples 1 to 10 was remarkably improved, compared to Comparative Examples 1 to 3 in which another metal complex was added instead of the component (C). The results show that copper complexes with ligands having electron withdrawing groups exhibit good humidity resistance. The comparison of Example 1 with Comparative Example 2 suggests that as for the central metal, copper, which is an intermediate acid, binds more tightly to the ligand than scandium does, which is a hard acid, in complexes with ligands having electron withdrawing groups.

The comparison of Examples 1, and 3 to 6 with Example 2 revealed that Examples 1, and 3 to 6, which used a ligand having an electron withdrawing group containing a fluorine atom in the component (C), had more improved humidity resistance compared to Example 2, which did not contain a fluorine atom in the electron withdrawing group of the component (C).

As is obvious from Table 1, in Examples 1, 4, and 6 to 10, which used a ligand having an electron withdrawing group having a fluorine number of 4 or more in the component (C), showed better initial fluorescence quantum yields and improved durability against light, reaching 500 hours or more, compared to Examples 3 and 5, which did not contain an electron withdrawing group having a fluorine number of 4 or more in the component (C).

As is obvious from the comparison of Examples 1 and 6 with Example 4, Examples 1 and 6, which used a ligand having a perfluoroalkyl group having a carbon number of 2 or more as an electron withdrawing group in the component (C), had more improved humidity resistance compared to Example 4, which did not have the above-described perfluoroalkyl group as the electron withdrawing group of the component (C).

As is obvious from the comparison of Examples 1 and 3 to 6 with Example 2, Examples 1 and 3 to 6 which used a ligand, in which Rb in the general formula (1) is a hydrogen atom, in the component (C), had more improved durability against light compared to Example 2.

As is obvious from a comparison of Example 3 with Example 5, Example 3 which used a ligand, in which X¹ and X² in the general formula (1) are both O, in the component (C) had better initial fluorescence quantum yield compared to Example 5.

In addition, the comparison results of Examples 1 and 6 with Examples 7 and 8 show that when the luminescent material, which is the component (A), has an electron withdrawing group, the reduction of the initial fluorescence quantum yield can be suppressed.

### INDUSTRIAL APPLICABILITY

As described above, the color conversion composition according to the present invention, the color conversion sheet, the light source unit, the display device, and the illumination apparatus are useful to improve durability against light and humidity resistance, and suitable for the color conversion composition, the color conversion sheet, the light source unit, the display device, and the illumination apparatus, showing excellent durability against light and humidity resistance.

### REFERENCE SIGNS LIST

1A, 1B, 1C, 1D Color Conversion Sheet
10 Substrate Layer
11 Color Conversion Layer
12 Barrier Film

1. A color conversion composition comprising the following components (A), (B), and (C):
Component (A): a luminescent material,
Component (B): a binder resin, and
Component (C): a compound of the following general formula (1): 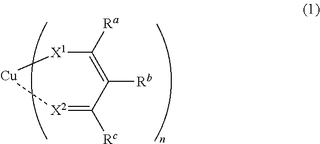
(wherein in the general formula (1),
each of X¹ and X² independently is O or S;
each of R^{a} to R^{c} is independently selected from the group consisting of a hydrogen atom, an alkyl group, a cycloalkyl group, a heterocyclic group, an alkenyl group, a cycloalkenyl group, an alkynyl group, a hydroxyl group, an alkoxy group, a thiol group, an alkylthio group, an aryl ether group, an aryl thioether group, an aryl group, a heteroaryl group, halogen, a cyano group, an aldehyde group, an oxycarbonyl group, a carbamoyl group, an amino group, a nitro group, a silyl group, a siloxanyl group, a boryl group, a phosphine oxide group, —C(═O)R¹⁰¹, —S(═O)R¹⁰²R¹⁰³, —S(═O)R¹⁰⁴, —S(═O)₂R¹⁰⁵, and a fused ring or an aliphatic ring each formed between adjacent substituents;
R¹⁰¹ to R¹⁰⁵ are substituents, and R¹⁰² and R¹⁰³ may be fused with each other to form a ring, provided that at least one of R^{a} to R^{c} is an electron withdrawing group; and
n is an integer of 1 to 4).

2. The color conversion composition according to claim 1, wherein the electron withdrawing group is a group containing a fluorine atom.

3. The color conversion composition according to claim 1, wherein the electron withdrawing group is a group having 4 or more fluorine atoms.

4. The color conversion composition according to claim 1, wherein the electron withdrawing group is a perfluoroalkyl group having 2 or more carbon atoms.

5. The color conversion composition according to claim 1, wherein Rb in the general formula (1) is a hydrogen atom.

6. The color conversion composition according to claim 1, wherein X¹ and X² in the general formula (1) are both O.

7. The color conversion composition according to claim 1, wherein the component (A) contains a compound of the following general formula (2): 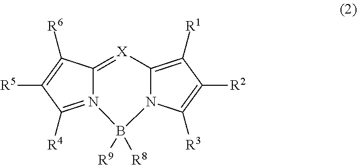
(wherein in the general formula (2),
X is C—R⁷ or N; and
each of R¹ to R⁹, which may be the same as or different from one another, is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, a phosphine oxide group, and a fused ring or an aliphatic ring each formed between adjacent substituents).

8. The color conversion composition according to claim 7, wherein at least one of R¹ to R⁶ in the general formula (2) is an electron withdrawing group,
X in the general formula (2) is C—R⁷, and
the R⁷ is a group of the following general formula (3): 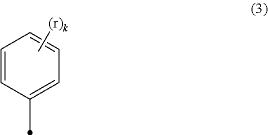
(wherein in the general formula (3),
r is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an aryl ether group, an aryl thioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, and a phosphine oxide group;
k is an integer of 1 to 3; and
when k is 2 or more, r may be the same as or different from one another).

9. The color conversion composition according to claim 1, wherein the component (A) contains at least one of the following luminescent materials (a) and (b):
luminescent material (a): a luminescent material that emits light having a peak wavelength observed in the region of 500 nm to less than 580 nm by use of excitation light having a wavelength of 400 nm to 500 nm, and
luminescent material (b): a luminescent material that emits light having a peak wavelength observed in the region of 580 nm to 750 nm when excited by at least one of excitation light having a wavelength of 400 nm to 500 nm and light emitted by the luminescent material (a).

10. The color conversion composition according to claim 1, wherein the component (B) is a thermoplastic resin.

11. A color conversion sheet comprising the color conversion composition according to claim 1, or a cured product thereof.

12. A light source unit, comprising:
a light source; and
the color conversion composition according to claim 1.

13. The light source unit according to claim 12, wherein the light source is a light-emitting diode having a maximum light emission in the range of 400 nm to 500 nm.

14. A display device, comprising the light source unit according to claim 12.

15. An illumination apparatus, comprising the light source unit according to claim 12.
